(19) United States
(12) Patent Application Publication
(10) Pub. No.: US 2014/0272696 A1
(43) Pub. Date: Sep. 18, 2014

(54) TONER, DEVELOPMENT AGENT, AND IMAGE FORMING METHOD

(71) Applicants: Hiroshi YAMASHITA, Shizuoka (JP); Toyoshi Sawada, Kanagawa (JP); Hideyuki Santo, Kanagawa (JP)

(72) Inventors: Hiroshi YAMASHITA, Shizuoka (JP); Toyoshi Sawada, Kanagawa (JP); Hideyuki Santo, Kanagawa (JP)

(21) Appl. No.: 14/171,962

(22) Filed: Feb. 4, 2014

(30) Foreign Application Priority Data
Mar. 15, 2013 (JP) 2013-054302

(51) Int. Cl. G03G 9/08

(52) U.S. Cl. CPC G03G 9/0821
USPC 430/108.4; 430/109.1; 430/109.5; 430/108.1; 430/123.5

(57) ABSTRACT

Toner contains a mother toner particle that contains a crystalline resin; and wax; and a coloring agent, wherein the area of endothermic peak derived from the crystalline resin during a first temperature rising as measured by differential scanning calorimetry is at least 20 J/g, wherein the ratio of the area of endothermic peak derived from the wax during a second time temperature rising as measured by differential scanning calorimetry (DSC) to the area of endothermic peak derived from the wax during a first time temperature rising as measured by differential scanning calorimetry is at least 0.50, wherein the ratio of the area of endothermic peak derived from the wax during a first time temperature rising as measured by differential scanning calorimetry to the area of endothermic peak derived from the crystalline resin during a first temperature rising as measured by differential scanning calorimetry is at least 0.10.

### CROSS-REFERENCE TO RELATED APPLICATIONS

This patent application is based on and claims priority pursuant to 35 U.S.C. §119 to Japanese Patent Application No. 2013-054302 filed on Mar. 15, 2013, in the Japan Patent Office, the entire disclosure of which is hereby incorporated by reference herein.

### BACKGROUND

1. Technical Field

The present invention relates to a toner, a development agent, and an image forming method.

2. Background Art

Conventionally, in the electrophotography, latent electrostatic images formed on an image bearing member (typically photoreceptor) are developed with toner to form toner images. The toner image is transferred to a recording medium, typically paper, and thereafter fixed thereon using heat, etc.

In an image forming apparatus employing a heating fixing system, since a large amount of energy is required in the fixing process of fusing the toner by heat to fix the toner on a recording medium, fixing the toner at a low temperature is necessary in terms of energy-saving.

For example, JP-2010-77419-A and JP2010-151996-A disclose toner containing a crystalline resin as a binder resin to improve the low temperature fixability of toner.

Also, good balance of the low temperature fixing property and hot offset resistance are desired.

However, since crystalline resins are not quick in recrystallization, the modulus of elasticity thereof during cooling down is lower than that during heating.

For this reason, problems arise that the toner image fixed on a recording medium is easily damaged by members such as discharging rollers and direction controlling members (ribs) arranged during the transfer path of the recording medium in an image forming apparatus.

### SUMMARY

The present invention provides improved toner containing: a mother toner particle that contains a crystalline resin; and wax; and a coloring agent, wherein the area of endothermic peak derived from the crystalline resin during a first temperature rising as measured by differential scanning calorimetry is at least 20 J/g, wherein the ratio of the area of endothermic peak derived from the wax during a second time temperature rising as measured by differential scanning calorimetry (DSC) to the area of endothermic peak derived from the wax during a first time temperature rising as measured by differential scanning calorimetry is at least 0.50, wherein the ratio of the area of endothermic peak derived from the wax during a first time temperature rising as measured by differential scanning calorimetry to the area of endothermic peak derived from the crystalline resin during a first temperature rising as measured by differential scanning calorimetry is at least 0.10.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIGURE is a diagram illustrating a dividing method when endothermic peaks are overlapped.

### DETAILED DESCRIPTION

The present invention provides toner having excellent low temperature fixability and hot offset resistance while suppressing occurrence of marks of discharging rollers and other members on a fixed image.

According to an embodiment of the present invention, toner is provided which has excellent low temperature fixability and hot offset resistance while suppressing occurrence of marks of discharging rollers and other members on a fixed image.

Next, embodiments of the present disclosure are described with reference to accompanying drawings.

Toner contains mother toner particles that contains crystalline resins and wax.

The area Sc1 of endothermic peak derived from the crystalline resin of the toner of the present disclosure during temperature rising for the first time as measured by differential scanning calorimetry (DSC) is 20 J/g or greater. When the Sc1 is too small, toner tends not to be fixed at low temperatures.

The ratio of the area Sw2 of endothermic peak derived from the wax of the toner of the present disclosure during temperature rising for the second time as measured by differential scanning calorimetry (DSC) to the area Sw1 of endothermic peak derived from the wax of the toner of the present disclosure during temperature rising for the first time as measured by differential scanning calorimetry (DSC) is 0.50 or higher. When the ratio of Sw2 to Sw1 is too small, marks of discharging rollers and direction controlling members (ribs) occur on a toner image.

The ratio of the area Sw1 of endothermic peak derived from the wax of the toner of the present disclosure during temperature rising for the first time as measured by differential scanning calorimetry (DSC) to the area Sc1 of endothermic peak derived from the crystalline resin of the toner of the present disclosure during temperature rising for the first time as measured by differential scanning calorimetry (DSC) is 0.10 or higher. When the ratio of Sw1 to Sc1 is too small, the hot offset resistance of toner tends to be reduced.

For this reason, even if the elasticity of crystalline resin during cooling is low, it is possible to reduce the attachability of toner image to discharging rollers, direction controlling members (ribs), etc., that is, tackiness is made small, thereby suppressing occurrence of marks of rollers, ribs, etc.

Wax is separated from toner when toner containing a large amount of crystalline resin is heated and thereafter cooled down, which lowers the tackiness of toner.

The area Sw1 of endothermic peak derived from the wax of the toner of the present disclosure during temperature rising for the first time as measured by differential scanning calorimetry (DSC) is 20 J/g or greater. When the Sw1 is too small, the hot offset resistance of toner tends to deteriorate.

However, if the elasticity of the crystalline resin during cooling down is increased by increasing the cross-linking degree or molecular weight of the crystalline resin, the low temperature fixability of the toner deteriorates.

In addition, in some cases, the tackiness of toner is not decreased by increasing the content of wax in toner having a large amount of crystalline resins. Consequently, the present inventors infer that the wax and the crystalline resins become compatible while being heated.

To prevent this compatibility between the wax and the crystalline resin from increasing during heating, the ratio of Sw2 to Sw1 is 0.50 or higher, that is, the area of endothermic peak as measured by differential scanning calorimetry is not easily decreased during the second time heating as compared with that during first time heating followed by cooling down.

In order for wax to release crystalline resins sufficiently, the ratio of Sw1 to Sc1 is considerably large, for example, 0.10 or higher, that is, the area of endothermic peak derived from the wax of toner during temperature rising for the first time is considerably large in comparison with the area of endothermic peak derived from the crystalline resin of toner during temperature rising for the first time.

When the endotherm peak derived from a crystalline resin overlaps the endotherm peak derived from wax, those two are perpendicularly divided by a normal at the bottom between the two peaks as illustrated in FIG. 1.

Furthermore, to obtain a low compatibility between a crystalline resin and wax, it is preferable that the solubility of crystalline resin to 30% by weight ethyl solution at 50° C. is 10% by weight or less, i.e., the solubility of wax to crystalline resin is low.

Furthermore, the peak of tackiness of toner during cooling when the attachment amount of the toner ranges from 0.55 mg/cm² to 0.65 mg/cm² is 30 gf or less while present between 30° C. and 100° C. This contributes to further reduction of occurrence of marks of discharging rollers, ribs, etc.

As for the crystalline resin, it is preferable to introduce urethane bonding and/or urea bonding capable of hydrogen bonding into the crystalline resin, meaning that the crystalline resin has a structure that binds molecules having not excessively low viscosity when melted at high temperatures.

As a result of an investigation made by the present inventors, it was found that the hardness of a crystalline resin was increased due to agglomeration increased by introducing such bondings into the crystalline resin.

In addition, it was also found that, by using two kinds of crystalline resins having urethane bonding and/or urea bonding, which have different molecular weights, the degree of crystallinity of toner as a whole is efficiently controlled, thereby improving the hot offset resistance of the toner.

In addition, typically, wax having a good separability with a crystalline resin easily exudes to the surface of the toner. If a wax dispersant having a similar structure to that of such toner is used, it is possible to suppress exudation of the wax to the surface of the toner. It is also suitable to form a layer containing a crystalline resin on the surface of a mother toner particle. Consequently, it is possible to suppress degradation of the fluidity of the toner, thereby improving replenishing property and transferability of the toner. In addition, in the case of a two component development system, if toner agglomerates in development agent, coarse particles thereof are formed. As a result, defective images are output due to void (of colorant) of such coarse particles. This void can be suppressed.

Wax having a polar group or a fork in the middle of its main hydrocarbon chain is preferable to impart polarity to some degree. This contributes to impart separability or releasability to wax against crystalline polyester.

There is no specific limit to the selection of the polar group. Specific examples thereof include, but are not limited to, nitrogen-containing functional groups, an amino group, an amide bonding, an ester bonding, and an ether bonding. Of these, a carboxyl group or a hydroxyl group is preferable.

The melting point of the wax is normally around that of the crystalline resin but can be high unless it surpasses the fixing temperature. Preferably, the melting point ranges from 50° C. to 90° C.

Content of Crystalline Resin

To strike a balance between the low temperature fixability and hot offset resistance at a high level, the content of the crystalline resin in the toner is preferably from 30% by weight to 90% by weight.

Definition of Crystallinity

The crystalline resin preferably has a ratio of the softening point to the maximum peak temperature of melting heat of from 0.80 to 1.55. The softening point is measured by a (elevated) flow tester and the maximum peak temperature is measured by a differential scanning calorimeter (DSC).

Resins characterized by rapid softening by heat are defined as the crystalline resin.

Resins characterized by slow softening by heat are defined as the crystalline resin.

The softening temperature of the resin and the toner can be measured by a flow tester (e.g., CFT-500D, manufactured by SHIMADZU CORPORATION) as follows: A load of 30 kg/cm² is applied to one gram of a sample resin by a plunger while heating the sample resin at a temperature rising speed of 3° C./min. to squeeze it from a nozzle having a diameter of 0.5 mm and a length of 1 mm; the plunger descending amount of the flow tester against the temperature is plotted; and the temperature at which a half of the sample has flown out is defined as the softening temperature.

The maximum peak temperature of the melting heat of the resin and the toner can be measured by a differential scanning calorimeter (DSC) (for example, TA-60WS and DSC-60, manufactured by SHIMADZU CORPORATION) as follows:

As preliminary treatment, the sample supplied to the measurement of the maximum peak temperature of the melting heat is melted at 130° C.; the melted material is cooled down from 130° C. to 70° C. at a temperature falling speed of 1.0° C./min.; thereafter, the resultant is cooled down from 70° C. to 10° C. at a temperature falling speed of 0.5° C./min.;

The sample is heated by DSC at a temperature rising speed of 20° C./min. once to measure the change of endotherm and exotherm; A graph of “amount of endotherm and exotherm” and “temperature” is drawn; The endotherm peak temperature observed between 20° C. to 100° C. is defined as “Ta*”; If there are multiple endotherm peaks, the temperature at which the amount of endotherm is the largest is determined as Ta*; Thereafter, the sample is preserved at (Ta*−10)° C. for six hours and thereafter, at (Ta*−15)° C. for another six hours; Then, the sample is cooled down by DSC to 0° C. at a temperature falling speed of 0.5° C./min.; the sample is heated at a temperature rising speed of 20° C./min. to measure the change of endotherm and exotherm; A graph as described above is drawn; The temperature corresponding to the maximum peak of the amount of endotherm and exotherm is determined as the maximum peak temperature of the melting heat.

In addition, the toner is heated from 0° C. to 130° C. at a temperature rising speed of 10° C./min. to measure the endotherm and exotherm; a graph of “amount of endotherm and exotherm and temperature is drawn; the area of endotherm peak derived from the crystalline resin is defined as Sc1 and the area of endotherm peak derived from the wax is defined as Sw1. Thereafter, the toner is cooled down at a temperature falling speed of 10° C./min.; the toner is heated again from 0° C. to 130° C. at a temperature rising speed of 10° C./min. to measure the change of endotherm and exotherm; and the area of endotherm peak derived from the wax is defined as Sw2.

Crystalline Resin

The crystalline resin is defined as described above. Preferable specific examples thereof include, but are not limited to, a polyester resin synthesized by a diol component and a dicarboxylic acid component, a lactone ting opening polymer, and a polyhydroxy carboxylic acid polymer.

In addition, other specific examples include, but are not limited to, compound having a urethane bonding/and or a urea bonding such as urethane-modified polyester resin, a urea-modified polyester resin, a polyurethane resin, and a polyurea resin. Of these, a urethane-modified polyester resin and a urea-modified polyester resin are preferable in terms that these have high hardness while sustaining crystallinity as a resin.

Urethane-Modified Crystalline Polyester Resin

The urea-modified polyester resin can be obtained by, for example, reaction between a polyester resin and a di- or higher isocyanate compound or reaction between a polyester resin having an isocyanate group at its end and a polyol component.

Specific examples of the polyester resin include, but are not limited to, polycondensed polyester resins synthesized by polycondensation of a diol component and a carboxylic acid component, lactone ring opening polymers, and polyhydroxycarboxylic acid. Among these, the polycondensed polyester resins synthesized by polycondensation of a diol and a carboxylic acid are preferable in terms of demonstration of the crystallinity.

Diol Component

As the diol component, aliphatic diols are preferable and the number of carbon atoms in the chain is preferably from 2 to 36. The aliphatic diols are classified into the straight chain type and the branch-chain type. The straight-chain type aliphatic diols are preferable and the straight-chain type aliphatic diols having four to six carbon atoms are more preferable. As the diol component, multiple diol components can be used. The content of the straight-chain type aliphatic diols is preferably 80% by mol or higher and more preferably 90% by mol or higher based on the total content of the diol component. When the content is within this range (80% by mol or higher), the crystallinity of the resin ameliorates and the combination of the low temperature fixability and the high temperature stability is good, which is preferable in terms of the tendency of improvement of the hardness of the resin.

Specific examples of the straight-chain type aliphatic diols include, but are not limited to, ethylene glycol, 1,3-propane diol, 1,4-butane diol, 1,5-pentane diol, 1,6-hexane diol, 1,7 heptane diol, 1,8-octane diol, 1,9-nonane diol, 1,10-decane diol, 1,11-undecane diol, 1,12-dodecane diol, 1,13-tridecane diol, 1,14-tetradecane diol, 1,15-pentadecane diol, 1,16-hexane dacane diol, 1,17-heptadecane diol, 1,18-octadecane diol, and 1,20-eicosane diol. Among these, considering the availability, ethylene glycol, 1,3-prpane diol, 1,4-butane diol, 1,6-hexane diol, 1,9-nonane diol, and 1,10-decane diol are preferable. 1,4-butane diol and 1,6-hexane diol are more preferable.

Specific examples of optional diols include, but are not limited to, aliphatic diols having 2 to 36 carbon atoms other than the specified above (e.g., 1,2-propylene glycol, 1,3-butane diol, hexane diol, octane diol, decane diol, dodecane diol, tetradecane diol, neopentyl glycol, and 2,2-diethyl-1,3-propane diol); alkylene ether glycols having 4 to 36 carbon atoms (e.g., diethylene glycol, triethylene glycol, dipropylene glycol, polyethylene glycol, polypropylene glycol, and polytetramethylene ether glycol); alicyclic diols having 4 to 36 carbon atoms (e.g., 1,4-cyclohexane dimethanol and hydrogenated bisphenol); Adducts of the alicyclic diols specified above with 1 mol to 30 mols of alkylene oxide (hereinafter referred to as AO) such as ethylene oxide (hereinafter referred to as EO), propylene oxide (hereinafter referred to as PO), and butylene oxide (hereinafter referred to as BO); adducts of bisphenols (e.g., bisphenol A, bisphenol F, and bisphenol S) with 2 mols to 30 mols of AO (EO, PO, BO, etc.); polylactone diols (e.g., polyε-caprolactone diol); and polybutadiene diol).

Specific examples of the optional tri- or higher alcohol components include, but are not limited to, tri- or higher aliphatic polyols having 3 to 36 carbon atoms (e.g., alkane polyools and inner or inter molecular dehydrated compounds thereof, e.g., glycerine, trimethylol ethane, trimethylol propane, pentaerythritol, sorbitol, sorbitane, and polyglycerine); Sugars and derivatives thereof (e.g., sucrose and methyl glucoside); adducts of trisphenols (e.g., triphenol PA) with 2 mols to 30 mols of AO; adducts of novolac resins (e.g., phenolic novolac and cresol novolac) with 2 mols to 30 mols of AO; and copolymers of acrylic polyol (e.g., copolymers of hydroxyethyl(meth)acrylate and another vinyl-based monomer).

Among these, tri- or higher aliphatic polyols and adducts of novolac resins with AO are preferable and adducts of novolac resins with AO are more preferable.

Dicarboxylic Acid

Preferred specific examples of the carboxylic acid components include, but are not limited to, aliphatic dicarboxylic acids and aromatic dicarboxylic acids. The aliphatic dicarboxylic acids are classified into the straight chain type and the branch-chained type. The straight chain type dicarboxylic acids are more preferable. Among these straight chain type dicarboxylic acids, saturated aliphatic dicarboxylic acids having from 6 to 12 carbon atoms are particularly preferable.

Specific examples of the dicarboxylic acid include, but are not limited to, alkane dicarboxylic acids having 4 to 36 carbon atoms such as succinic acid, adipic acid, azelaic acid, sebacic acid, dodecane dicarboxylic acid, tetradecane dicarboxylic acid, hexadecane dicarboxylic acid, and octadecane dicarboxylic acid; alicyclic dicarboxylic acids having 6 to carbon atoms such as dimer acid (dimerized linolic acid); alkene dicarboxylic acids having 4 to 36 carbon atoms such as alkenyl succinic acids such as dodecenyl succinic acid, pentadecenyl succinic acid, and octadecenyl succinic, maleic acid, fumaric acid, and citraconic acid; and aromatic dicarboxylic acids having 8 to 36 carbon atoms such as phthalic acid, isophthalic acid, terephthalic acid, t-butyl isophthalic acid, 2,6-naphthalene dicarboxylic acid, and 4,4′-biphenyl dicarboxylic acid).

Specific examples of the optional polycarboxylic acids having three or more hydroxyl groups include, but are not limited to, aromatic polycarboxylic acids having 9 to 20 carbon atoms (e.g., trimellitic acid and pyromellitic acid).

As the dicarboxylic acid or polycarboxylic acids having three or more hydroxyl groups, anhydrides or lower alkyl esters (e.g., methyl esters, ethyl esters, or isopropyl esters) having one to four carbon atoms can be used.

Among these dicarboxylic acids, it is preferable to use the aliphatic dicarboxylic acids (preferably adipic acid, sebacic acid, and dodecane dicarboxylic acid) singly or in combination. Copolymers of the aliphatic dicarboxylic acids and the aromatic dicarboxylic acids (preferably isophthalic acid, terephthalic acid, t-butyl isophthalic acid, and lower alkyl esters thereof) are also preferable. The amount of copolymerized aromatic dicarboxylic acid is preferably 20% by mol or less.

Lactone Ring-Opening Polymer

The lactone ring-opening polymers as the polyester resin can be obtained by, for example, ring-opening polymerizing a lactone such as a monolactone (the number of ester groups is one in the ring) having 3 to 12 carbon atoms such as β-propio lactone, γ-butylo lactone, δ-valero lactone, and ε-capro lactone using a catalyst such as a metal oxide and an organic metal compound. Among these, ε-capro lactone is preferable in terms of crystallinity.

In addition, lactone ring-opening polymers having a hydroxyl group at their end obtained by ring-opening polymerizing the lactones specified above using a glycol (e.g., ethylene glycol and diethylene glycol) as an initiator are suitable. Also the end can be modified to be a carboxyl group. Products available from the market can be also used. These are, for example, high-crystalline polycapro lactones such as PLACCEL series H1P, H4, H5, and H7 (manufactured by DAICEL CORPORATION).

Polyhydroxy Carboxylic Acid

Polyhydroxy carboxylic acids as the polyester resins are obtained by direct dehydrocondensation of hydroxycarboxylic acid such as a glycolic acid, lactic acid (L-, D- and meso form). However, it is preferable to obtain them by ring-opening a cyclic ester (the number of ester groups in the ring is two or three) having 4 to 12 carbon atoms corresponding to an inter two or three molecule dehydrocondensed compound of a hydroxycarboxylic acid such as glycolide and lactide (L-, D- and meso form) with a catalyst such as a metal oxide and an organic metal compound in terms of controlling the molecular weight. Among these, preferable cyclic esters are L-lactide and D-lactide in light of crystallinity. In addition, these polyhydrocarboxylic acids that are modified to have a hydroxy group or a carboxyli group at the end are also suitable.

Di- or Higher Isocyanate Component

Specific examples of the isocyanate compounds include, but are not limited to, aromatic isocyanates, aliphatic isocyanates, alicyclic isocyanates, and aromatic aliphatic isocyanates (among these, for example, aromatic diisocyanates having 6 to 20 carbon atoms, aliphatic diisocyanates having 2 to 18 carbon atoms, alicyclic diisocyanates having 4 to 15 carbon atoms, aromatic aliphatic diisocyanates having 8 to 15 carbon atoms, modified diisocyanates thereof (modified compounds having a urethane group, a cabodiimide group, an allophanate group, a urea group, a biuret group, a uretdione group, a uretimine group, an isocyanulate group, and an oxazoline group), and mixtures thereof, in which he number of carbon atoms specified above excludes the number of carbon atoms in NCO group). Optionally, tri- or higher isocynates can be used in combination therewith.

Specific examples of the aromatic isocyanates include, but are not limited to, 1,3- and/or 1,4-phenylene diisocyanate, 2,4- and/or 2,6-tolylene diisocyanate (TDI), crude TDI, 2,4′- and/or 4,4′-diphenyl methane diisocyanate (MDI), crude MDI (phosgenized compound of crude diamino diphenyl methane (condensed products of formaldehyde and aromatic amine (aniline) or its mixture; mixtures of diamino diphenyl methane with a small quantity (e.g., 5% by weight to 20% by weight) of tri- or higher polyamines), polyaryl polyisocyanate (PAPI), 1,5-naphtylene diisocyanate, 4,4′4″-triphenyl methane triisocyanate, and m- or p-isocyanato phenyl sulfonyl isocyanate.

Specific examples of the aliphatic isocyanates include, but are not limited to, ethylene diisocyanate, tetramethylene diisocyanate, hexamethylene diisocyanate (HDI), dodecamethylene diisocyanate, 1,6,11-undecane triisocyanate, 2,2,4-trimethyl hexamethylene diisocyanate, lysine diisocyanate, 2,6-diisocyanato methyl caproate, bis(2-isocyanato ethyl)fumarate, bis(2-isocyanato ethyl)carbonate, and 2-isocyanatoethyl-2,6-diisocyanato hexanoate.

Specific examples of the alicyclic isocyanates include, but are not limited to, isophorone diisocyanate (IPDI), dicyclo hexyl methane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- and/or 2,6-norbornane diisocyanate.

Specific examples of the aromatic aliphatic diisocyanates include, but are not limited to, m- and/or p-xylylene diisocyanate (XDI), α,α,α′,α′-tetramethyl xylylene diisocyanate (TMXDI).

Specific examples of the modified compounds of the diisocyanates include, but are not limited to, modified compounds having a urethane group, a cabodiimide group, an allophanate group, a urea group, a biuret group, a uretdione group, a uretimine group, an isocyanulate group, and an oxazoline group. To be specific, these are: modified MDI such as urethane modified MDI, carbodiimide modified MDI, and trihydrocarbyl phosphate modified MDI), modified compounds of diisocyanates such as urethane modified TDI, and mixtures thereof such as modified MDI and urethane modified TDI (prepolymer containing isocyanate).

Among these, aromatic diisocyanates having 6 to 15 carbon atoms, aliphatic diisocyanates having 4 to 12 carbon atoms, alicyclic diisocyanates having 4 to 15 carbon atoms are preferable, in which the number of carbon atoms excludes the number of carbon atoms in NCO group. Among these, TDI, MDI, HDI, hydrogenated MDI, and IPDI are particularly preferable.

Urea-Modified Crystalline Polyester Resin

It is possible to obtain a urea-modified polyester resin by reacting a polyester resin having an isocyanate group at its end with an amine compound.

Di- or Higher Amine Component

Specific examples of the amine component include, but are not limited to, aliphatic amines and aromatic amines. Among these, aliphatic diamines having 2 to 18 carbon atoms and aromatic diamines having 6 to 20 carbon atoms are suitable. Optionally, tri- or higher amines can be used.

Specific examples of the aliphatic diamines having 2 to 18 carbon atoms include, but are not limited to, alkylene diamines such as ethylene diamine, propylene diamine, trimethylene diamine, tetramethylene diamine, and hexamethylene diamine; polyalkylene diamines having 4 to 18 carbon atoms such as diethylene triamine, iminobis propyl amine, bis(hexamethylene)triamine, triethylene tetramine, tetraethylene pentamine, and pentaethylene hexamine; substituted compounds thereof with an alkyl having 1 to 4 carbon atoms or a hydroxyl alkyl having 2 to 4 carbon atoms such as dialkyl aminopropyl amine, trimethyl hexamethylene diamine, aminoethyl ethanol amine, 2,5-dimethyl-2,5-hexamethylene diamine, and methyl iminobispropyl amine; alicyclic or heterocyclic aliphatic diamines such as alicyclic diamine having 4 to 15 carbon atoms such as 1,3-diamino cyclehexane, isophorone diamine, menthene diamine, 4,4′-methylene dicyclohexane diamine (hydrogenated methylene dianiline and heterocyclic diamine having 4 to 15 carbon atoms such as piperazine, N-aminoethyl piperazine, 1,4-diaminoethyl piperazine, 1,4,-bis(2-amino-2-methylpropyl)piperazine, 3,9-bis(3-aminopropyl)-2,4,8,10-tetraoxaspiro[5,5]undecane; and aromatic aliphatic amines having 8 to 15 carbon atoms such as xylylene diamine, tetrachlor-p-xylylene diamine.

Specific examples of the aromatic diamines having 6 to 20 carbon atoms include, but are not limited to, non-substituted aromatic diamines such as 1,2-, 1,3, or 1,4-phenylene diamine, 2,4,3- or 4,4′-diphenyl methane diamine, crude diphenyl methane diamine (polyphenyl polymethylene polyamine), diaminodiphenyl sulfone, bendidine, thiodianiline, bis(3,4-diaminophenyl)sulfone, 2,6-diaminopilidine, m-aminobenzyl amine, triphenyl methane-4,4′,4″-triamine, and naphtylene diamine; aromatic diamines having a nuclear substitution alkyl group having one to four carbon atoms such as 2,4- or 2,6-tolylene diamine, crude tolylene diamine, diethyle tolylene diamine, 4,4′-diamino-3,3′-dimethyldiphenyl methane, 4,4′-bis(o-toluidine), dianisidine, diamino ditolyl sulfone, 1,3-dimethyl-2,4-diaminobenzene, 1,3-dimethyl-2,6-diaminobenzene, 1,4-diisopropyl-2,5-diamino benzene, 2,4-diamino mesitylene, 1-methyl-3,5-diethyl-2,4-diamino benzene, 2,3-dimethyl-1,4-diamino naphthalene, 2,6-dimethyl-1,5-diamino naphthalene, 3,3′,5,5′-tetramethyl bendizine, 3,3′,5,5′-tetramethyl-4,4′-diamino diphenyl methane, 3,5-diethyl-3′-methyl-2′,4-diamino diphenyl methane, 3,3′diethyl-2,2′-diaminodiphenyl methane, 4,4′-diamino-3,3′-dimethyl diphenylmethane, 3,3′,5,5′-tetraethyl-4,4′-diaminobenzophenone, 3,3′,5,5′-tetraethyl-4,4′-diaminodiphenyl ether, 3,3′,5,5′-tetraisopropyl-4,4′-diaminophenyl sulfone; mixtures of isomers thereof with various ratios; aromatic diamines having a nuclear substitution electron withdrawing group (such as halogen (e.g., Cl, Br, I, anf F), alkoxy groups such as methoxy group and ethoxy group, and nitro group) such as methylene bis-o-chloroaniline, 4-chlor-o-phenylene diamine, 2-chlor-1,4-phenylene diamine, 3-amino-4-chloroaniline, 4-bromo-1,3-phenylene diamine, 2,5-dichlor-1,4-phenylene diamine, 5-nitro-1,3-phenylene diamine, 3-dimethoxy-4-aminoaniline; 4,4′-diamino-3,3′-dimethyl-5,5′-dibromo-diphenyl methane, 3,3′-dichlorobenzidine, 3,3′dimethoxy benzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sufide, bis(4-aminophenyl)telluride, bis(4-aminophenyl)selenide, bis(4-amino-3-methoxyphenyl)disulfide, 4,4′-methylene bis(2-iodoaniline), 4,4′-methylene bis(2-bromoaniline), 4,4′-methylene bis(2-fluoroaniline), 4-aminophenyl-2-chloroaniline); aromatic diamines having a secondary amino group such as the non-substituted aromatic diamines specified above, the aromatic diamines having a nuclear substitution alkyl group having one to four carbon atoms, mixtures of isomers thereof with various mixing ratio, compounds in which part or entire of the primary amine group of the aromatic diamines having a nuclear substitution electron withdrawing group specified above is substituted with a lower alkyl group such as methyl group and ethyl group to be a tertiary amino group, 4-4′-di(methylamino)diphenyl methane, and 1-methyl-2-methylamino-4-aminobenzene.

Specific examples of the tri- or higher amines include, but are not limited to, polyamide polyamines (low-molecular weight polyamide polyamines obtained by condensation of dicarboxylix acid (e.g., dimeric acid) and excessive (2 mols or more per mol of acid) polyamines (e.g., the alkylene diamines specified above and polyalkylene polyamines specified above) and hydrogenated compounds of cyanoethylated polyether polyamines (e.g., polyether polyols such as polyalkeylene glycol).

Polyurethane Resin

Among the polyurethane resins, polyurethane resins synthesized from a diol component and a diisocyanate component are suitably used. Optionally, tri- or higher alcohol components and isocyanate components can be used.

Specific examples of the diol component and the diisocyanate component and the tri- or higher alcohol components and isocyanate components are the same as mentioned above.

Polyurea Resin

Among the polyurea resins, polyurea resins synthesized from a diamine component and a diisocyanate component are suitably used. Optionally, tri- or higher amine components and isocyanate components can be used.

Specific examples of the diamine component and the diisocyanate component and the tri- or higher amine components and isocyanate components are the same as mentioned above.

Melting Point of Crystalline Resin

The maximum peak temperature of the melting heat of the crystalline resin described above is preferably from 45° C. to 70° C., more preferably from 53° C. to 65° C., and particularly preferably from 58° C. to 62° C. in terms of the combination of the low temperature fixability and the high temperature stability. When the maximum peak temperature is too low, the low temperature fixability ameliorates but the high temperature storage tends to deteriorate and the toner and the carrier (toner carrier) tend to agglomerate due to stirring stress in the development device, which is not preferable. To the contrary, when the maximum peak temperature is too high, the high temperature stability ameliorates but the low temperature fixability tends to deteriorate, which is not preferable.

The ratio {the softening temperature to the maximum peak temperature of the melting heat} of the softening temperature to the maximum peak temperature of the melting heat of the crystalline resin is preferably from 0.80 to 1.55, more preferably from 0.85 to 1.25, furthermore preferably from 0.90 to 1.20, and particularly preferably from 0.90 to 1.19. A resin with this ratio having a value closer to 1.00 has a characteristic of drastic softening and is excellent in terms of having a good combination of the low temperature fixability and the high temperature stability.

The weight average molecular weight (Mw) of the crystalline resin D is preferably from 10,000 to 40,000, more preferably from 15,000 to 35,000, and particularly preferably from 20,000 to 30,000. When the molecular weight is too small, the high temperature stability of the toner tends to deteriorate and when the molecular weight is too large, the low temperature fixability of the toner tends to deteriorate, which is not preferable.

The weight average molecular weight (Mw) of the resin can be measured by using a gel permeation chromatography (GPC) measuring device (for example, GPC-8220 GPC, manufactured by TOSOH CORPORATION). The column is TSK gel Super HZM-M 15 cm triplet (manufactured by TOSOH CORPORATION). The resin to be measured is dissolved to obtain a 0.15% by weight solution of tetrahydrofuran (THF) (containing a stabilizer, manufactured by WAKO PURE CHEMICAL INDUSTRIES, LTD.) followed by filtration using a filter having an opening of 0.2 μm. The resultant filtrate is used as a sample. 100 μl of the THF sample solution is infused into the measuring instrument under the condition that the temperature is 40° C. and the flow speed is 0.35 ml/min. The molecular weight of the sample is calculated based on the relation between the logarithm value of the standard curve made from several kinds of the monodispersed polystyrene standard samples and the count value. The monodispersed polystyrene standard samples are: Showdex STANDARD Std. No S-7300, S-210, S-390, S-875, S-1980, S10.9, S-629, S-3.0, and S-0.580 (manufactured by SHOWA DENKO K.K.) and toluene. An refractive index (R1) detector is used as the detector.

Block resins that have crystalline portions and non-crystalline portions are suitable as the crystalline resin of the present disclosure. The crystalline resins specified above can be used for the crystalline portions. As resins for use in forming the non-crystalline portions, specific examples thereof include, but are not limited to, polyester resins, polyurethane resins, and polyurea resins. The composition of these non-crystalline portions is the same as that of the crystalline portion. Specific examples of the monomer for use include, but are not limited to, the diol components specified above, the dicarboxylic acid components specified above, the diisocyanate components specified above, and the diamine components specified above. Any combination thereof that can form a non-crystalline resin is suitable.

The crystalline resin can be obtained by polymerization caused by reaction between a crystalline resin precursor having a functional group at its end which is reactive with an active hydrogen group and a resin having an active hydrogen group or a cross-linking agent or an elongation agent having an active hydrogen group in the toner manufacturing process. The crystalline resin precursor is obtained by reacting the resins mentioned above such as the crystalline polyester resin, the urethane modified crystalline polyester resin, the urea modified crystalline polyester resin, the crystalline polyurethane resin, and the crystalline polyurea resin with a compound having a functional group reactive with the active hydrogen group.

There is no specific limit to the functional group reactive with an active hydrogen group. Specific examples thereof include, but are not limited to, functional groups such as an isocyanate group, an epoxy group, a carboxylic acid group, and an acid chloride group. Among these, an isocyanate group is preferable in terms of the reaction property and the stability. A specific example of the compound having an isocyanate group is the diisocyanate component described above.

To obtain the crystalline resin precursor E′, for example, in a case of the reaction of the crystalline polyester resin mentioned above and the diisocyanate component mentioned above, it is preferable to use a crystalline polyester resin having a hydroxy group at its end as the crystalline polyester resin.

The crystalline polyester resin having a hydroxy group is obtained by reaction conducted at an equivalent ratio of the hydroxy group [OH] to the carboxylic group [COOH] for the ratio of the diol component to the dicarboxylic acid component from 2/1 to 1/1, more preferably from 1.5/1 to 1/1, and particularly from 1.3/1 to 1.02/1.

With regard to the usage amount of the compound having a functional group reactive with an active hydrogen group, for example, in a case of the crystalline resin precursor B′ obtained by reacting a crystalline polyester resin having a hydroxy group with a diisocyanate component, the ratio of the diisocyanate component represented by the equivalent ratio {[NCO]/[OH]} of the isocyanate group [NCO] to the hydroxy group [OH] of the crystalline polyester resin having a hydroxy group is preferably from 5/1 to 1/1, more preferably from 4/1 to 1.2/1, and particularly preferably from 2.5/1 to 1.5/1. In a case of the crystalline resin precursor B′ having another skeleton and/or terminal group, just the components are different, so that the ratio is the same.

There is no specific limit to the compounds such as the above-specified resin having an active hydrogen group and the above-specified cross-linking agent or elongation agent having an active hydrogen group and any compound having an active hydrogen group is suitably used. When the above-specified functional group reactive with an active hydrogen group is the isocyanate group, resins having a hydroxy group (alcoholic hydroxy group and phenolic hydroxy group), amino group, carboxylic group, mercapto group, etc. are suitable. Water and amines are particularly suitable in terms of the reaction speed.

There is no specific limitation to the amines. Specific examples thereof include, but are not limited to, phenylene diamine, diethyltoluene diamine, 4,4′-diamino diphenyl methane, 4,4′-diamino-3,3′-dimethyldicyclo hexylmethane, diamine cyclohexane, isophorone diamine, ethylene diamine, tetramethylene diamine, hexamethylene dimaine, diethylene triamine, triethylene tetramine, ethanol amine, hydroxyethyl aniline, aminoethyl mercaptan, aminopropyl meracaptan, amino propionic acid, and amino caproic acid. In addition, ketimine compounds and oxazolidine compounds in which these amino groups are blocked with ketones (acetone, methylethyl ketone, and methylisobutyl ketone) are also suitable.

The crystalline resin can be used with a non-crystalline resin as the binder resin.

There is no specific limit to the non-crystalline resin. Any resin having a non-crystalline property can be suitably used. Specific examples thereof include, but are not limited to, styrene mono-polymers and substituted styrene mono-polymers such as polystyrene and polyvinyltoluene; styrene copolymers such as styrene-methyl acrylate copolymers, styrene methacrylate copolymers, styrene-methyl methacrylate copolymers, styrene-acrylonitrile copolymers, styrene-vinyl methyl ether copolymers, styrene-vinyl methyl ketone copolymers, styrene-vinyl methyl ketone copolymers, styrene-butadiene copolymers, and styrene-maleic acid ester copolymers; other resins such as polymethyl methacrylate resins, polybutyl methacrylate resins, polyvinyl acetate resins, polyethylene resins, polyesters resins, polyurethane resins, epoxy resins, polyvinyl butyral resins, polyacrylic resins, rosin resins, modified rosin resins, and resins modified to have a functional group reactive with an active hydrogen group. These resins can be used alone or in combination.

Wax

Wax having a polar group or a fork in the middle of its main chain is preferable to impart polarity to some degree. The melting point of the wax is normally around that of the crystalline resin or can be high unless it surpasses the temperature of the image on a recording medium during fixing.

Specific examples of the polar group include, but are not limited to, modified waxes into which a polar group such as a hydroxyl group, a carboxylic group, an amide group, an amino group is introduced. Other specific examples include, but are not limited to, oxidized wax obtained by oxidizing a hydrocarbon by an aerial oxidation method, metal salts thereof such as potassium and sodium, a polymer having an acidic group such as a copolymer of a copolymer of maleic anhydride and α-olefine, salts thereof, imide esters, quaternary amine salts, and alkoxized compounds of hydroxyl group-modified hydrocarbons.

Specific examples of the waxes having a carbonyl group include, but are not limited to, polyalkane acid esters, polyalkanol esters, polyalkane acid amides, polyalkyl amides, and dialkyl ketones.

Specific examples of the polyalkane acid esters include, but are not limited to, carnauba wax, montan wax, trimethylol propane tribehenate, pentaerythritol tetrabehenate, pentaerythritol diacetate dibehenate, glycerin tribehenate, and 1,18-octadecanediol distearate. Specific examples of the polyalkanol esters include, but are not limited to, trimellitic acid tristearyl and distearyl maleate. A specific example of the polyalkane acid amide is dibehenyl amide. A specific example of the polyalkyl amide is trimellitic acid tristearyl amide. A specific example of the dialkyl ketone is distearyl ketone. Among these waxes having a carbonyl group, the polyalkane acid esters are particularly preferable.

Specific examples of the polyolefin waxes include, but are not limited to, polyethylene waxes and polypropylene waxes.

Specific examples of the long-chain hydrocarbons include, but are not limited to, paraffin wax and sazol wax.

There is no specific limit to the melting point of the wax. Any can be selected to a particular application. The melting point is preferably from 50° C. to 100° C. and more preferably from 60° C. to 90° C. When the melting point of the releasing agent is too low, the high temperature stability of the toner tends to deteriorate. To the contrary, when the melting point is too high, a cold offset problem, i.e., an offset phenomenon that occurs at a low fixing temperature, tends to occur.

The melting point of the wax can be measured by a differential scanning calorimeter (for example, TA-60WS or DSC-60, manufactured by Shimadzu Corporation) as follows: 5.0 mg of the wax is put in an aluminum sample container; the sample container is placed on a holder unit; and they are set in an electric furnace. Next, the temperature of the electric furnace is raised in nitrogen atmosphere from 0° C. to 150° C. at a temperature rising speed of 10° C./min. Thereafter, the temperature is fallen from 150° C. to 0° C. at a temperature falling speed of 10° C./min. Then, the temperature is raised in nitrogen atmosphere from 0° C. to 150° C. at a temperature rising speed of 10° C./min. again to plot a differential scanning calorimetry (DSC) curve From the obtained DSC curve, using an analysis program installed in the DSC-60 system, the maximum peak temperature of the melting heat during the second time temperature rising is determined as the melting pint.

The wax preferably has a melt viscosity measured at 100° C. of from 5 mPa·sec to 100 mPa·sec, more preferably from 5 mPa·sec to 50 mPa·sec., and particularly preferably from 5 mPa·sec to 20 mPa·sec. When the melt viscosity is too small, the releasability tends to deteriorate. When the melt viscosity is too large, the releasability at low temperatures and the hot offset resistance tend to deteriorate, which is not preferable.

The content of the wax in the toner increases as the content of the crystalline resin therein. The content of wax is preferably from 10% by weight to 50% by weight and more preferably from 20% by weight to 40% by weight to toner. When the content is too small, hot offset resistance tends to deteriorate and when the content is too large, high temperature stability, chargeability, transferability, and stress-resistance tend to deteriorate, which is not preferable.

Coloring Agent (Colorant)

There is no specific limit to the coloring agent for use in the toner of the present disclosure and any known coloring agent can be selected for use.

There is no specific limit to the color of the coloring agent for use in the toner of the present disclosure. One or more can be selected from black toner, cyan toner, magenta toner, and yellow toner and various kinds of colors can be obtained by selecting the coloring agents. The color toner is preferable.

Specific examples of the black color toner include, but are not limited to, carbon black (C.I. Pigment Black 7) such as furnace black, lamp black, acetylene black, and channel black, metals such as copper, iron (C.I. Pigment Black 11), and titanium oxides, and organic pigments such as aniline black (C.I. Pigment Black 1).

Specific examples of the pigments for magenta include, but are not limited to, C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 150, 163, 177, 179, 184, 202, 206, 207, 209, 211, 269; C.I. Pigment Violet 19; C.I. Vat Red 1, 2, 10, 13, 15, 23, 29, and 35.

Specific examples of the pigments for magenta include, but are not limited to, C.I. Pigment Blue 2, 3, 15, 15:1, 15:2, 15:3, 15:4, 15:6, 16, 17, 60; C.I. Vat Blue 6; C.I. Acid Blue 45; Copper phthalocyanine pigments in which one to five phthal imidemethyl groups are substituted in the phthalocyanine skeleton; and Green 7 and Green 36.

Specific examples of the pigments for yellow include, but are not limited to, C.I. Pigment Yellow 12, 3, 4, 5, 6, 7, 10, 11, 12, 13, 14, 15, 16, 17, 23, 55, 65, 73, 74, 83, 97, 110, 139, 151, 154, 155, 180; C.I. Vat Yellow 1, 3, and 20; and Orange 36.

The content of the coloring agent in the toner is preferably from 1% by weight to 15% by weight and more preferably from 3% by weight to 10% by weight. When the content of the coloring agent is too small, the coloring performance of the toner tends to deteriorate. To the contrary, when the content of the coloring agent is too great, dispersion of the pigment in the toner tends to be insufficient, thereby degrading the coloring performance and the electric characteristics of the toner.

The coloring agent and the resin can be used in combination as a master batch. There is no specific limit to such resins. In terms of the compatibility with the binder resin in the present disclosure, using the binder resin for use in the present disclosure or resins having a structure similar thereto is preferable.

The master batch can be manufactured by applying a high shearing force to the resin and the coloring agent for mixing and/or kneading. In this case, an organic solvent can be used to boost the interaction between the coloring agent and the resin. In addition, so-called flushing methods are advantageous in that there is no need to drying because a wet cake of the coloring agent can be used as they are. The flushing method is a method in which a water paste containing water of a coloring agent is mixed or kneaded with an organic solvent and the coloring agent is transferred to the resin side to remove water and the organic solvent. High shearing dispersion devices such as a three-roll mill, etc. can be used for mixing or kneading.

Charge Control Agent

In addition, to impart a suitable charging power to the toner, it is possible to optionally contain a charge control agent.

Any known charge control agent is suitably usable. However, colorless or white materials (including materials close thereto) are preferable because color materials may have an impact on the coloring. Specific examples thereof include, but are not limited to, triphenylmethane dyes, chelate pigments of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and metal salts of salicylic acid derivatives. These can be used alone or in combination.

The content of the charge control agent is determined depending on the kinds of the binder resin and the toner manufacturing method (including the dispersion method) and therefore is not unambiguously defined. However, the content of the charge control agent is preferably from 0.01% by weight to 5% by weight and more preferably from 0.02% by weight to 2% by weight based on the binder resin. When the addition amount is too large, the toner tends to have an excessively large size of charge, which reduces the effect of the charge control agent. Therefore, the electrostatic attraction force between the developing roller and the toner increases, resulting in deterioration of the fluidity of the development agent and insufficient charge starting property and size of charge, which may have an adverse impact on the toner images.

External Additive

In the toner of the present disclosure, it is possible to add external additives to reform the fluidity and adjust the size of charge and the electric characteristics. There is no specific limit to the external additives and any known external additives is suitably usable. Specific examples thereof include, but are not limited to, silica particulates, hydrophobized silica particulates, aliphatic acid metal salts (such as zinc stearate and aluminum stearate); metal oxides (such as titania, alumina, tin oxide, antimony oxide) and hydrophobized compounds thereof, and fluoropolymers. Among these, hydrophobized silica particulates, titania particles, and hydrophobized titania particulates are preferable.

Specific examples of the hydrophobized silica particles include, but are not limited to, HDK H 2000, HDK H 2000/4, HDK H 2050 EP, HVK21, HDK H 1303, (all manufactured by HOECHST AG), R972, R974, RX200, RY200, R202, R805, and R812 (manufactured by NIPPON AEROSIL CO., LTD.). In addition, specific examples of the titania particulates include, but are not limited to, P-25 (manufactured by NIPPON AEROSIL CO., LTD.), STT-30 and STT-65C-S (manufactured by TITAN KOGYO, LTD.), TAF-140 (manufactured by FUJI TITANIUM INDUSTRY CO., LTD.), and MT-150W, MT-500B, MT-600B, and MT-150A (manufactured by TAYCA CORPORATION). Specific examples of the hydrophobized titan oxide particulates include, but are not limited to, T-805 (manufactured by NIPPON AEROSIL CO., LTD.); STT-30A and STT-65S-S (manufactured by TITAN KOGYO, LTD.); TAF-500T and TAF-1500T (manufactured by FUJI TITANIUM INDUSTRY CO., LTD.); MT-100S and MT-100T (manufactured by TAYCA CORPORATION); and IT-S (manufactured by ISHIHARA SANGYO KAISHA LTD.).

The hydrophobized silica particulates, the hydrophobized titania particulates, and the hydrophobized alumina particulates can be obtained by treating hydrophillic particulates with a silane coupling agent such as methyl trimethoxyxilane, methyltriethoxy silane, and octyl trimethoxysilane. Specific examples of hydrophobizing agents include, but are not limited to, silane coupling agents such as dialkyl dihalogenated silane, trialkyl halogenized silane, alkyl trihalogenized silane, and hexa alkyl disilazane; silylating agents, silane coupling agents having an alkyl fluoride group, organic titanate coupling agents, aluminum-containing coupling agents, silicone oil, and silicone varnish.

The inorganic particulate preferably has an average primary particle diameter of from 1 nm to 100 nm and more preferably from 3 nm to 70 nm. When the average particle diameter is too small, the organic particulates are buried in the toner, so that the its features are not suitably demonstrated. When the average particle diameter is too large, the surface of the image bearing member may be damaged unevenly. Inorganic particulates and hydrophobized inorganic particulates can be used in combination as the external additives. It is more preferable that the external additives contain two or more kinds of inorganic particulates having an average primary particle diameter of 20 nm or less and one or more kinds of inorganic particulates having an average primary particle diameter of 30 nm or more. In addition, the specific surface area of such inorganic particulates as measured by the BET method is preferably from 20 m²/g to 500 m²/g.

The content of the external additive is preferably from 0.1% by weight to 5% by weight and more preferably from 0.3% by weight to 3% by weight based on the toner.

Resin particulates can be added as the external additives. Specific examples thereof include, but are not limited to, polystyrene prepared by a soap-free emulsion polymerization method, a suspension polymerization method, or a dispersion polymerization method; and copolymers of methacrylic acid esters and acrylic acid esters; polycondensation resins such as silicone resins, benzoguanamine resins, and nylon resins, and polymerized particles by a thermocuring resin. By a combinational use of such resin particulates, the chargeability of the toner is improved, thereby reducing the reversely charged toner, resulting in a decrease in background fouling.

The content of the resin particulates is preferably from 0.01% by weight to 5% by weight and more preferably from 0.1% by weight to 2% by weight, based on the toner.

Method of Manufacturing Toner

There is no specific limitation to any method of manufacturing the toner of the present disclosure and any material thereof that satisfy the conditions. For example, a mixing, kneading, and pulverizing method and a method of granulating toner particles in an aqueous medium, so called chemical manufacturing methods, are suitably used.

Specific examples of the chemical manufacturing method include, but are not limited to, a suspension polymerization method, an emulsification polymerization method, a seed polymerization method, and a dispersion polymerization method that manufacture a toner using a monomer as the initial material; a dissolution suspension method of dissolving a resin precursor and a resin followed by dispersion and/or emulsification in an aqueous medium; a method of emulsifying and/or dispersing an oil phase composition containing a resin precursor (prepolymer containing a reactive group) having a functional group reactive with an active hydrogen group in an aqueous medium containing resin particulates to react a compound having an active hydrogen group with the prepolymer having a reactive group in the dissolution suspension method (manufacturing method I); a phase change emulsification method of adding water to a solution containing a resin, a resin precursor, and a suitable emulsifier; and an agglomeration method of granulating the resin particles obtained by these methods, which are dispersed in the aqueous medium, followed by heating, melting, etc. to obtain particles having a desired size. Among these, the toner obtained by the dissolution suspension method, the manufacturing method I, and the agglomeration method is preferable in light of the granularity (easiness of controlling the particle size distribution, controlling of particle forms, etc.) of the crystalline resin. The toner obtained by the manufacturing method I is more preferable.

These manufacturing methods are described in detail below.

In the mixing, kneading, and pulverizing method, for example, a toner material containing at least a coloring agent, a binder resin, and wax (releasing agent) is melted and mixed and kneaded, and thereafter pulverized and classified to manufacture mother particles of the toner described above.

In the melting, mixing, and kneading, the toner material are mixed and placed in a melting, mixing and kneading machine for melting, mixing, and kneading. Single-screw or twin-screw continuous mixing and kneading machines or batch type mixing and kneading machines by a roll mill can be used as the melting and mixing and kneading machine. Specific examples thereof include, but are not limited to, KTK type twin-screw extruder (manufactured by KOBE STEEL., LTD.), TEM type extruder (manufactured by TOSHIBA MACHINE CO., LTD), twin-screw extruder (manufactured by KCK), PCM type twin-screw extruder (manufactured by Ikegai Corp.), and Ko-kneaders (manufactured by Buss). This melting and mixing and kneading are required to be conducted under suitable conditions not to sever the molecular chain of the binder resins. To be specific, the temperature in the melting and mixing and kneading operation is determined referring to the softening point of the binder resin. When the temperature is too high relative to the softening point, the molecular chain tends to be severely severed. When the temperature is too high relative to the softening point, dispersion tends not to proceed smoothly.

In the pulverization process, the mixture obtained in the mixing and kneading is pulverized. In the pulverization process, it is preferable to coarsely pulverize the mixed and kneaded materials first followed by fine pulverization. In this process, kneaded mixtures are pulverized by collision with a collision board in a jet stream, collision between particles in a jet stream, and pulverization at narrow gaps between a stator and a rotor that is mechanically rotating, etc.

The classification process adjusts the pulverized material obtained in the pulverization process by classification to have a predetermined particle diameter. The classification can be performed by removing particulate portions using a cyclone, a decanter, or a centrifugal.

After the pulverization and classification, the pulverized material is classified into an air stream by centrifugal, etc. to manufacture mother toner particles having a predetermined particle diameter.

In the dissolution suspension method, for example, mother particles of the toner are manufactured by dispersing and/or emulsifying an oil phase composition in which a toner composition having at least a binder resin, a binder resin precursor, a coloring agent, and wax is dissolved and/or dispersed in an organic solvent in an aqueous medium.

The organic solvent to dissolve or disperse the toner composition is preferably volatile with a boiling point lower than 100° C. in order to easily remove the organic solvent later.

Specific examples of the organic solvents include, but are not limited to, ester- or ester ether-based solvents such as ethyl acetate, butyl acetate, methoxy acetate, methyl cellosolve acetate, and ethyl cellosolve acetate; ether based solvents such as diethyl ether, tetrahydrofuran, dioxane, ethyl cellosolvem butyl cellosolve, and propylene glycol monomethyl ether; ketone-based solvents such as acetone, methyl ethylketone, methyl isobutyl ketone, di-n-butyl ketone, and cyclohexanone; alcohol-based solvents such as methanol, ethanol, n-propanol, isopropanol, n-butanol, isobutanol, t-butanol, 2-ethylhexyl alcohol, and benzyl alcohol; and mixtures thereof.

In the dissolution suspension method, it is possible to optionally use an emulsifier and a dispersant when dispersing and/or emulsifying the oil composition in the aqueous medium.

Any known surface active agent and hydrosoluble polymer can be used as the emulsifier and the dispersant. There is no specific limit to the surface active agent. Specific examples thereof include, but are not limited to, anion surface active agents (e.g., alkyl benzene sulphonic acid, and phosphoric acid esters), cationic surface active agents (e.g., quaternary ammonium salt type and amine salt type), amopholic surface active agents (e.g., carboxylic acid salt type, sulfuric acid ester salt type, sulphonic acid salt type, and phosphoric acid ester salt type), and non-ion surface active agents (e.g., AO addition type and polyol type). These surface active agents can be used alone or in combination.

Specific examples of the hydrosoluble polymers include, but are not limited to, cellulose-based compounds (e.g., methyl cellulose, ethyl cellulose, hydroxyethyl cellulose, ethyl hydroxyethyl cellulose, carboxy methyl cellulose, hydroxypropyl cellulose, and saponified compounds thereof; gelatine, starch, dextrine, gum arabic, chitin, chitosan, polyvinyl alcohol, polyvinyl pyrrolidone, polyethylene glycol, polyethylene imine, polyacryl amide, acrylic acid (salt) containing polymers (e.g., neutralized compounds of sodium hydroxide portion of polyacrylic acid sodium, polyacrylic acid potassium, polyacrylic acid ammonium, and polyacrylic acid, and copolymers of acrylic acid sodium and acrylic acid ester), neutralized compounds of sodium hydroxide portion of a copolymer of styrene and maleic anhydride, hydrosoluble polyurethane (reaction products of polyethylene glycol, polycaprolactone diol, etc. with polyisocyanate).

In addition, the organic solvents mentioned above and plasticizers can be used in combination as a helping agent for emulsification or dispersion.

It is preferable to prepare toner by, in the dissolution suspension method, dispersing or emulsifying an oil phase composition containing at least a binder resin, a binder resin precursor having a reactive group with an active hydrogen (reactive group-containing prepolymer), a coloring agent, and wax in an aqueous medium containing resin particulates and granulating mother toner particles by reaction a compound having an active hydrogen group contained in the oil composition and/or the aqueous medium with the prepolymer having a reactive group (manufacturing method I).

Resin particulates can be formed through a known polymerization method. It is preferred to obtain an aqueous liquid dispersion of the resin particulates. For example, as the method of preparing an aqueous liquid dispersion of the resin particulates, the following methods of (a) to (h) can be used.

(a) A method of manufacturing an aqueous liquid dispersion of resin particulates directly from the polymerization reaction by a suspension polymerization method, an emulsification polymerization method, a seed polymerization method, or a dispersion polymerization method using a vinyl monomer as the initial material of the resin particulates.
(b) A method of manufacturing an aqueous liquid dispersion of resin particulates by: dispersing a precursor (monomer, oligomer, etc.) of a polyaddition- or polycondensation-based resin such as a polyester resin, a polyurethane resin, and an epoxy resin or its solvent solution under the presence of a suitable dispersion agent; curing the liquid dispersion by heating or addition of a curing agent.
(c) A method of dissolving an emulsifier in a precursor (monomer, oligomer, etc.) of a polyaddition or polycondensation resin such as a polyester resin, a polyurethane resin, and an epoxy resin or a solvent solution or its solvent solution (liquid is preferred, e.g., liquidized by heating) followed by adding water for phase change to prepare an aqueous liquid dispersion of resin particulates.
(d) A method of manufacturing an aqueous liquid dispersion of resin particulates by: fine-pulverizing resins preliminarily manufactured by a polymer reaction (addition polymerization, ring scission polymerization, polyaddition, addition condensation, polycondensation, etc.) with a fine grinding mill of a mechanical rotation type, jet type, etc.; classifying the resultant to obtain resin particulates; and dispersing the obtained resin particulates in water under the presence of a suitable dispersion agent.
(e) A method of manufacturing an aqueous liquid dispersion of resin particulates by: spraying in a form of a fine liquid mist a resin solution in which resins preliminarily synthesized by polymer reaction (addition polymerization, ring scission polymerization, polyaddition, addition condensation, polycondensation, etc.) are dissolved in a solvent to form resin particulates; and dispersing the obtained resin particulates in water under the presence of a suitable dispersion agent.
(f) A method of manufacturing an aqueous liquid dispersion of resin particulates by: precipitating resin particulates by adding a poor solvent to a resin solution in which resins preliminarily manufactured by a polymer reaction (addition polymerization, ring scission polymerization, polyaddition, addition condensation, polycondensation, etc.) are dissolved in another solvent or cooling down the resin solution preliminarily prepared by heating and dissolving in a solvent; removing the solvent to obtain resin particulates; and dispersing the obtained resin particulates in water under the presence of a suitable dispersion agent.
(g) A method of manufacturing an aqueous liquid dispersion of resin particulates by: dispersing in an aqueous medium a resin solution in which resins preliminarily manufactured by a polymer reaction (addition polymerization, ring scission polymerization, polyaddition, addition condensation, polycondensation, etc.) are dissolved in a solvent under the presence of a suitable dispersion agent; and removing the solvent by heating, reducing pressure, etc.
(h) A method of manufacturing an aqueous liquid dispersion of resin particulates by: dissolving a suitable emulsification agent in a resin solution in which resins preliminarily synthesized by a polymer reaction (addition polymerization, ring scission polymerization, polyaddition, addition condensation, polycondensation, etc.) are dissolved in a solvent; and adding water for phase change emulsification.

The resin particulate preferably has a volume average particle diameter of from 10 nm to 300 nm and more preferably from 30 nm to 120 nm. When the volume average particle diameter of the resin particulate is too small or large, the particle size distribution of the toner tends to deteriorate, which is not preferable.

The concentration of the solid portion of the oil phase is preferably from about 40% to about 80%. A concentration that is too high tends to make dissolution or dispersion difficult and also the viscosity becomes high, so that handling the solution or the liquid dispersion is difficult. A concentration that is too low results in deterioration in manufacturability of the toner.

Toner compositions other than binder resins such as the coloring agent and the wax and a master batch thereof may be separately dissolved or dispersed in an organic solvent and thereafter mixed with a binder resin solution or liquid dispersion.

The aqueous medium is not limited to simple water. Mixtures of water with a solvent which can be mixed with water are also suitably usable. Specific examples of such a mixable solvent include, but are not limited to, alcohols (e.g., methanol, isopropanol, and ethylene glycol), dimethylformamide, tetrahydrofuran, cellosolves (e.g., methyl cellosolve), lower ketones (e.g., acetone and methyl ethyl ketone), etc.

There is no particular limit to the method of the emulsification and dispersion in the aqueous medium. Known facilities employing a low speed shearing method, a high speed shearing method, a friction method, a high pressure jet method, an ultrasonic methods etc., can be used. Among these, the high speed shearing method is preferable in terms of size reduction of particles. When a high speed shearing type dispersion machine is used, there is no particular limitation to the rotation speed thereof. The rotation speed is typically from 1,000 rpm to 30,000 rpm, and preferably from 5,000 rpm to 20,000 rpm. The temperature during the dispersion process is typically from 0° C. to 150° C. (under pressure) and preferably from 20° C. to 80° C.

In order to remove the organic solvent from the thus prepared emulsion dispersion body, there is no specific limit to the removing method and any known method is suitable. For example, it is possible to employ a method of gradually raising the temperature of the emulsion dispersion body while stirring the system to completely evaporate and remove the organic solvent in the droplets.

Known technologies are used in the process of washing and drying mother toner particles dispersed in the aqueous medium. That is, after separation solid from liquid by a centrifugal or a filter press to obtain a toner cake, the obtained cake is re-dispersed in de-ionized water at room temperature to about 40° C. Subsequent to optional pH adjustment by an acid or an alkali, the resultant is subject to the solid and liquid separation treatment again. This process is repeated several times to remove impurities and the surface active agent. Thereafter, the resultant is dried by an air stream drier, a circulation drier, a reduced pressure drier, a vibration flow drier, etc. to obtain toner powder. Toner particulate components can be removed by a centrifugal and a known classifier can be optionally used after the drying process to obtain a toner having a desired particle size distribution.

In the agglomeration method, for example, the mother particles of the toner is manufactured by mixing a liquid dispersion of resin particulates containing a binder resin, a liquid dispersion of coloring agent particles, and optionally a liquid dispersion of wax particulates for agglomeration. The liquid dispersion of resin particulates can be obtained by a known method using, for example, an emulsification polymerization, a seed polymerization, and a phase change emulsification. The liquid dispersion of coloring agent particles and the liquid dispersion of wax particulates are obtained by a known wet dispersion method of dispersing a coloring agent or wax in an aqueous medium.

To control the agglomeration state, a method of heating, adding a metal salt, adjusting pH, etc. is preferably used.

There is no specific limit to the metal salt. Specific examples of the monovalent metal forming the metal salt include, but are not limited to, sodium and potassium. Specific examples of the divalent metal forming the metal salt include, but are not limited to, calcium and magnesium. A specific example of the trivalent metal forming the salt include, but are not limited to, aluminum

Specific examples of anions that form the salts include, but are not limited to, chloride ion, bromide ion, iodine ion, carbonate ion, and sulfuric acid ion. Among these, magnesium chloride, aluminum chloride, and complexes and polymers thereof are preferable.

In addition, it is possible to accelerate fusion of resin particles by heating during or after agglomeration, which is preferable in terms of uniformity of the toner. Furthermore, it is possible to control the form of toner by heating. As the toner is heated more and more, the toner form becomes closer to a sphere.

The methods described above are used for the process of washing and drying the mother toner particles dispersed in the aqueous medium.

Furthermore, inorganic particulates such as hydrophobic silica fine powder may be added to the thus-manufactured mother toner particles to improve the fluidity, the preservability, the development property, and the transfer property.

Although the additive is mixed by a typical powder mixer, a mixer having a jacket, etc. is preferable to adjust the internal temperature. To change the history of the load applied to the external additive, adding the additive in the midstream or little by little during mixing is suitable. It is also suitable to change the number of rotations, rolling speed, time, temperature, etc. of the mixer. Heavy load followed by relatively light load or vice versa is applicable. Specific examples of the mixers include, but are not limited to, V-type mixers, Rocking mixers, Lodige mixers, Nautor mixers, and Henschel mixers. Next, filtrate the mixture with a screen having 250 meshes or more to remove coarse particles and agglomerated particles to obtain toner.

There is no specific limit to the size and form of toner. It is preferable that the toner has the following average circularity, volume average particle diameter, the ratio (volume average particle diameter to number average particle diameter) of the volume average particle diameter to the number average particle diameter.

The average circularity is a value obtained by dividing the circumference of a circle corresponding to the projection area of the toner form by the circumference of the toner particle and is preferably from 0.950 to 0.980 and more preferably from 0.960 to 0.975. It is preferable that toner includes particles having an average circularity less than 0.95 in an amount of 15% or less.

When the average circularity is too small, e.g., less than 0.950, images having insufficient transferability without dust tends to be produced. When the average circularity is too large, for example, greater than 0.980, the cleaning performance for the image bearing member and the transfer belt becomes poor in an image forming system employing a blade cleaning system, which results in contamination on images, for example, background fouling caused by toner remaining on the image bearing member as a result of non-transferred toner ascribable to sheet feeding problems, etc. when forming images having a high image area ratio such as photographs or contamination on the charging roller to charge the image bearing member by contact, thereby inhibiting exhibition of the original charging capability.

The average circularity is calculated by measuring toner particles by a flow type particle image analyzer (FPIA-2100, manufactured by Sysmex Corporation) followed by analysis using an analysis software (FPIA-2100 Data Processing Program for FPIA version 00-10). To be specific, 0.1 ml to 0.5 ml of 10% by weight surface active agent (alkylbenzene sulfonate, NEOGEN SC-A, manufactured by Daiichi Kogyo Co., Ltd.) is placed in a glass beaker (100 ml). 0.5 g of each toner is added in the beaker and stirred by a microspatula. 80 ml of deionized water is added to the mixture. The thus-obtained liquid dispersion is subject to dispersion treatment by an ultrasonic wave dispersion device (manufactured by Honda Electronics). The toner form and distribution are measured for the liquid dispersion using FPIA-2100 until the concentration is 5,000 particles/μl to 15,000 particles/μl. In this measuring method, it is suitable to make the concentration of the liquid dispersion is 5,000 particles/μl to 15,000 particles/μl in terms of the measuring reproducibility of the average circularity. To obtain the concentration of the liquid dispersion, it is required to change the liquid dispersion, that is, the amount of the surface active agent to be added and the amount of toner. The required amount of the surface active agent varies depending on the hydrophobicity of the toner as in the measuring the toner particle diameter. If an excessively large amount is added, the noise tends to occur. If an excessively small amount is added, the toner tends to be insufficiently wet, resulting in insufficient dispersion. In addition, the addition amount of the toner depends on the particle diameter. In a case of a small particle diameter, the amount tends to be small and, a large particle diameter, large. When the toner particle diameter is from 3 μm to 10 μm, the addition amount of the toner is 0.1 g to 0.5 g, thereby adjusting the concentration of the liquid dispersion to be 5,000 particles/μl to 15,000 particles/μl.

There is no specific limit to the volume average particle diameter of the toner. For example, the toner preferably has a volume average particle diameter of from 3 μm to 10 μm and more preferably from 4 μm to 7 μm. When the volume average particle diameter is too small, toner tends to adhere to the surface of the carrier while stirring in the development device over an extended period of time, thereby degrading the charging power of the carrier in a case of a two component development agent. When the volume average particle diameter is too large, it tends to be difficult to produce quality images with high definition and the particle diameter of the toner tends to vary significantly when replenishing the toner in the development agent.

The ratio (volume average particle diameter to number average particle diameter) of the volume average particle diameter to the number average particle diameter in the toner is preferably from 1.00 to 1.25 and more preferably from 1.00 to 1.15.

The volume average particle diameter, the number average particle diameter, and the ratio (volume average particle diameter to number average particle diameter) are measured by using particle size measuring instrument (MULTISIZER III, manufactured by BECKMAN COULTER INC.) with an aperture diameter of 100 μm and analyzed by an analysis software (BECKMAN COULTER MULTISIZER 3 VERSION 3.51). To be specific, 0.5 ml of 10% by weight surface active agent (alkylbenzene sulfonate, NEOGEN SC-A, manufactured by Daiichi Kogyo Co., Ltd.) is placed in a glass beaker (100 ml). 0.5 g of each toner is added in the beaker and stirred by a microspatula. 80 ml of deionized water is added to the mixture. The thus-obtained liquid dispersion is subject to dispersion treatment for ten minutes by an ultrasonic wave dispersion device (W-113MK-II, manufactured by Honda Electronics). The liquid dispersion is measured by using the MULTISIZER III using ISOTON® III (manufactured by BECKMAN COULTER INC.) as the measuring solution. The liquid dispersion is dripped such that the concentration indicated by the measuring device is from 6 to 10%. In this measuring method, it is important to keep the concentration in the range mentioned above in terms of measuring reproducibility. The measured particle diameter does not have an error when the concentration is within that range.

The ratio (Tsh2nd/Tsh1st) of the shoulder temperature Tsh1st of the melting heat peak of the toner during first time temperature rising as measured by differential scanning calorimetry (DSC) to the shoulder temperature Tsh2nd of the melting heat peak of the toner during second time temperature rising as measured by differential scanning calorimetry (DSC) is preferably from 0.90 to 1.10.

The shoulder temperatures (Tsh1st and Tsh2nd) of the melting heat peaks of the toner can be measured by a differential scanning calorimeter (DSC) (for example, TA-60W and DSC-60, manufactured by SHIMADZU CORPORATION) as follows: That is, 5.0 mg of the toner is placed in an aluminum sample container and the sample container is set on a holder unit followed by setting them in an electric furnace. Next, the temperature is raised in nitrogen atmosphere from 0° C. to 150° C. at a temperature rising speed of 10° C./min. Thereafter, the temperature is lowered from 150° C. to 0° C. at a temperature falling speed of 10° C./min. Then, the temperature is raised again in nitrogen atmosphere from 0° C. to 150° C. at a temperature rising speed of 10° C./min. to plot a differential scanning calorimetry (DSC) curve. In the thus-obtained DSC curve, the endotherm peak temperature at the first time temperature raising is Tm1st and, the second time, Tm2nd.

Select the maximum if there are multiple endotherm peaks. With regard to respective endotherm peaks, the intersections of the base line on the lower temperatures from the endotherm peak and the tangent on the slope on the lower temperature side forming the endotherm peak are defined as Tsh1st and Tsh2nd.

With regard to the viscoelasticity of the toner, the storage elastic modulus G′ (70) at 70° C. is preferably from 5.0×10⁴ P [symbol] to 5.0×10⁵ P [symbol] . With regard to the viscoelasticity of the toner, the storage elastic modulus G′ (160) at 160° C. is preferably from 1.0×10³ P [symbol] to 1.0×10⁴ P [symbol] . When the G′ (70) is too small, strength of image immediately after fixing tend to deteriorate, thereby causing damage on the surface of the image, which is not preferable. When the G′ (70) is too large, the melt-fusion of the toner during low temperature fixing, causing deterioration of the low temperature fixability thereof, which is not preferable. When the G′ (160) is too small, hot offset resistance tends to deteriorate, which is not preferable. When the G′ (160) is too large, image gloss tends to deteriorate, which is not preferable.

The storage elastic modulus G′ of the toner can be measured by a dynamic viscoelasticity measuring device (for example, ARES, manufactured by TA INSTRUMENT JAPAN INC.) as follows: A sample is molded to a pellet having a diameter of 8 mm and a thickness of from 1 mm to 2 mm; the pellet is fixed to a parallel plate having a diameter of 8 mm and thereafter stabilized at 40° C.; and the system is heated to 200° C. at a temperature rising speed of 2.0° C./min. at a frequency of 1 Hz (6.28 rad/s) with a distortion amount (distortion amount control mode) of 0.1% for measurement.

The crystallinity of the toner of the present disclosure is preferably from 15% to 30% and more preferably from 20% to 25%. In addition, when the crystallinity is too small, the impact of the non-crystalline portion contained in the toner increases, so that the drastic response of the viscoelasticity to heat, which is inherent to a crystalline resin, is not maintained. Therefore, the low temperature fixability and the high temperature stability of the toner easily deteriorate, which is not preferable. On the other hand, when the value of the crystallinity is too great, the reduction of the hardness ascribable to the crystalline resin is not easily suppressed, which leads to carrier filming caused by stirring stress in the development device over an extended period of time and production of agglomerated particles, resulting in defective images, which is not preferable. It is possible to control the crystallinity of the toner by, for example, changing the mixing ratio of the crystalline resin and the non-crystalline resin or changing the crystallinity of the crystalline resin (e.g., changing the monomer compositions or the ratio of the crystalline portion to the non-crystalline portion of the block resin having a crystalline portion and a non-crystalline portion).

The crystallinity of the toner and the resin is an area ratio of the main diffraction peak to the halo in the diffraction profile obtained by X ray diffraction measuring. The calculation method of the X ray diffraction measuring and the crystallinity are described below.

Development Agent

The development agent contains at least the toner described above and other optional components such as carriers. The development agent can be a one-component development agent and a two-component development agent. The two-component development agent is preferable in terms of length of the working life particularly when used in a high speed printer that meets the demand for high speed information processing of late.

In a case of a one-component development agent using the toner described above is used, even when the toner is replenished, the change in the particle diameter of the toner is small, no filming of the toner on the developing roller serving as the development agent bearing member occurs, and no fusion bonding of the toner onto members such as a blade for regulating the thickness of the toner layer occurs. Therefore, good and stable developability is sustained to produce quality images even when the development agent is used (stirred) for an extended period of time. In a case of a two-component development agent using the toner described above is used, even when the toner is replenished for an extended period of time, the change in the particle diameter of the toner in the development agent is small. In addition, good and stable developability is sustained even when the development agent is stirred in the development device for an extended period of time.

Carrier

There is no specific limitation to the carrier. A carrier is preferable which contains a core material and a resin layer that covers the core material.

Carrier Core Material

There is no specific limit to the selection of the carrier core material and any particle having magnetism is suitable. Specific examples thereof include, but are not limited to, ferrite, magnetite, iron, and nickel. In addition, in the case of ferrite, considering the adaptability to the environment which has been of a high concern recently, it is preferable to use, for example, manganese ferrite, manganese-magnesium ferrite, manganese strontium ferrite, manganese-magnesium-strontium ferrite, and lithium-based ferrite instead of typical copper-zinc ferrite.

Cover Layer

The cover layer (protective layer) has at least a binder resin and optionally other components such as inorganic particulates.

Binder Resin

There is no specific limit to binder resin to form a cover layer of a carrier particle. Any known resin can be selected to a particular application. Specific examples thereof include, but are not limited to, polyolefins (such as polyethylene and polypropylene) and modified products thereof; Cross-linkable copolymer containing styrene, acrylic resins, acrylonitrile, vinyl acetate, vinyl alcohol, vinyl chloride, vinyl carbazole, and vinyl ether; silicone resins formed of organosilixane bond and modified products thereof (such as products modified by alkyd resins, polyester resins, epoxy resins, polyurethane, and polyimide); polyamides; polyester; polyurethane; polycarboate; urea resins; melamine resins; benzoguanamine resins; epoxy resins; ionomer resins; polyimide resins; and derivatives thereof. These can be used alone or in combination. Among these, silicone resins are particularly preferred.

There is no specific limit to the silicone resins and any known silicone resins are suitably used. Specific examples thereof include, but are not limited to, straight silicone resins formed of only organosiloxane bonding; and silicone resins modified by alkyd resins, polyester resins, epoxy resins, acrylic resins, urethane resins, etc.

Specific examples of the straight silicone resins include, but are not limited to, KR271, KR272, KR282, KR252, KR255, and KR152 (manufactured by Shin-Etsu CHEMICAL CO., LTD.); and SR2400, SR2405, and SR2406 (manufactured by DOW CORNING TORAY SILICONE CO., LTD.). Specific examples of modified silicone resins include, but are not limited to, epoxy-modified resins (e.g., ES-1001N), acrylic-modified silicone resins (e.g., KR-5208), polyester-modified silicone resins (e.g., KR-5203), alkyd-modified silicone resins (e.g., KR-206), urethane-modified silicone resins (e.g., KR-305) (all of which are manufactured by Shin-Etsu CHEMICAL CO., LTD.); epoxy-modified silicone resins (e.g., SR2115); and alkyd-modified silicone resins (e.g., SR2110) (all manufactured by DOW CORNING TORAY SILICONE CO., LTD.).

It is possible to use a simple silicone resin and also possible to use it with a component that conducts cross-linking reaction, a charge-control component, etc. simultaneously. A specific example of the charge control agents is a silane coupling agent. Specific examples of the silane coupling agents include, but are not limited to, methyl trimethoxy silane, methyl triethoxy silane, octyl trimethoxy silane, and amino silane coupling agents.

Particulate

The cover layer may contain particulates. There is no specific limit to the particulates and any known material is suitably used. Specific examples thereof include, but are not limited to, inorganic particulates such as metal powder, tin oxide, zinc oxide, alumina, potassium titanate, barium titanate, and aluminum borate; electroconductive polymer such as polyaniline, polyacetylaene, polyparaphenylene, poly(para-phenyl sulfide), polypyrrole, and parylene; and organic particulates such as carbon black.

The surface of the particulates may be electroconductive treated. A specific method of such electroconductive treatment is covering the surface of the particulate with a form of solid solution and fusion of aluminum, zinc, copper, nickel, silver, and alloyed metal thereof, zinc oxide, titanium oxide, tin oxide, antimony oxide, indium oxide, bismuth oxide, indium oxide in which tin is doped, tin oxide in which antimony is doped, or zirconium oxide. Among these, tin oxide, indium oxide, and indium oxide in which tin is doped are preferable.

The content of the cover layer in the carrier is preferably 5% by weight or more and more preferably from 5% by weight to 10% by weight.

The thickness of the cover layer is preferably from 0.1 μm to 5 μm and more preferably from 0.3 μm to 2 μm.

The thickness of the cover layer can be calculated as the average of the layer thickness obtained by observing 50 or more points of a carrier cross section using a transmission electron microscope (TEM) or scanning type transmission electron microscope (STEM) after making the carrier cross section by, for example, a focused ion beam (FIB).

### Method of Forming Carrier Cover Layer

There is no specific limit to the method of forming the cover layer of the carrier and any known method of forming a cover layer is usable. A specific example of the method is coating the surface of the carrier core material with a cover layer solution in which a raw material for the cover layer such as the binder resin and the precursor thereof mentioned above is dissolved by an air spraying method or a dip coating method. It is preferable to coat the surface of the core material with the cover layer solution (liquid cover) to form a carrier on which the cover layer is formed and heat the carrier to accelerate polymerization reaction of the binder resin or the precursor thereof. The heating treatment may be conducted in the coating device or by another separate heating device such as a typical electric furnace and a baking kiln, etc. after forming the cover layer.

Since the heating temperature depends on the materials for the cover layer, it is not possible to unambiguously determine the temperature. However, it is preferably from about 120° C. to about 350° C. and particularly preferably the decomposition temperature or lower of the materials for the cover layer. The decomposition temperature of the materials for the cover layer is preferably up to about 220° C. and the heating time is preferably from about 5 minutes to about 120 minutes.

Characteristics of Carrier

The volume average particle diameter of the carrier is preferably from 10 μm to 100 μm and more preferably from 20 μm to 65 μm. When the volume average particle diameter of the carrier is too small, the carrier attachment caused by degradation of the uniformity of the core material particles tends to occur, which is not preferable. When the volume average particle diameter of the carrier is too large, the reproducibility of detailed portions of an image easily worsens, so that a fine image is not obtained, which is not preferable.

There is no specific limit to the measuring method of the volume average particle diameter. Any known instrument that can measure the particle size distribution such as a microtrack particle size analyzer (model HRA 9320-X100, manufactured by NIKK ISO CO., LTD.) is suitably usable.

The volume resistance of the carrier is preferably from 9 [log(Ω·cm)] to 16 [log(Ω·cm)] and more preferably from 10 [log(Ω·cm)] to 14 [log(Ω·cm)]. A volume resistivity of the carrier that is too small tends to cause carrier attachment at non-image portions, which is not preferable. A volume average particle diameter of the carrier that is too large tends to cause the edge effect, in which the image density at edge portions is emphasized during development. The volume resistivity can be adjusted arbitrarily in the range by adjusting the thickness of the cover layer of the carrier and the content of the electroconductive particulate.

A method of measuring the volume resistivity is, for example: fill with the carrier a cell having a fluorine-containing resin container quipped with electrodes 1a and 1b with a gap of 0.2 cm therebetween and a surface area of 2.5 cm×4 cm; tap the cell under the following conditions: falling height: 1 cm; tapping speed: 30 times/minute; and number of tapping: ten times. Thereafter, apply a direct voltage of 1,000 V between both electrodes: and measure a resistance r [Ω] after 30 seconds by a high resistance meter (HIGH RESISTANCE METER 4329A, manufactured by HEWLETT-PACKARD, JAPAN, LTD.) to calculate the volume resistivity R [log(Ω·cm)] according to the following relation 1.

R=Log {r [Ω]×(2.5 [cm]×4 [cm])/0.2 [cm]} Relation 1

When the development agent described above is a two component development agent, the mixing ratio of the toner to the carrier is preferably from 2.0% by weight to 12.0% by weight and more preferably from 2.5% by weight to 10.0% by weight.

Image Forming Method and Image Forming Apparatus

The image formation method includes a latent electrostatic image forming process, a development process, a transfer process, and a fixing process with optional processes such as a cleaning process, a discharging process, a recycling process, and a control process.

The image forming apparatus of the present disclosure includes at least a latent electrostatic image bearing member (photoreceptor), a latent electrostatic image forming device (irradiator), a container to accommodate a development agent containing toner, a development device, a transfer device, and a fixing device with optional devices such as a cleaning device, a discharging device, a recycling device, and a control device.

Latent Image Forming Process and Latent Image Forming Device

The latent electrostatic image forming process is to form a latent electrostatic image on an image bearing member.

There is no specific limit to the latent electrostatic image bearing member with regard to the material, form, structure and the size thereof and any known image bearing member can be used and suitably selected. The image bearing member suitably employs a drum-like form or a belt-like form. Also, an inorganic image bearing member formed of amorphous silicon or selenium or an organic image bearing member formed of polysilane, or phthalopolymethine is suitably used. Of these, amorphous silicon, etc. is preferred in terms of long working life.

The latent electrostatic image is formed by, for example, uniformly charging the surface of the latent electrostatic image bearing member followed by irradiation according to data information with the latent image formation device.

The latent electrostatic image forming device includes at least a charger which uniformly charges the surface of the latent electrostatic image bearing member, an irradiator which irradiates the surface of the latent electrostatic image bearing member according to obtained image information.

The surface of the latent electrostatic image bearing member is charged by, for example, applying a voltage to the surface of the latent electrostatic image bearing member with the charger.

There is no specific limit to the charger and any known charger can be selected. A known contact type charger having an electroconductive or semi-electroconductive roll, brush, film, rubber blade, etc. and a non-contact type charger such as a corotron or a scorotron which uses corona discharging can be used.

It is preferable to arrange the charger in contact with or in the vicinity of the latent electrostatic image bearing member to apply a direct voltage or a voltage obtained by superimposing an alternating voltage to a direct voltage to the surface of the latent electrostatic image bearing member.

In addition, it is preferable to apply a direct voltage or a voltage obtained by superimposing an alternating voltage to a direct voltage to the surface of the latent image bearing member by a charging roller arranged in the vicinity (non-contact) of the latent image bearing member via a gap tape.

The irradiator irradiates the surface of the image bearing member according to obtained image information.

Specific examples of such an irradiator include, but are not limited to, a photocopying optical system, a rod lens array system, a laser optical system, and a liquid crystal shutter optical system.

Also, a rear side irradiation system in which the image bearing member is irradiated from the rear side thereof can be also employed.

Development Process and Development Device

The development process is to form a visible image by developing the latent electrostatic image with toner or a development agent.

The visible image is formed by, for example, developing the latent electrostatic image by the development device with the development agent.

There is not specific limit to the development agent. Any known development device that can conduct development with the development agent is suitably selected. For example, a development device that has a development unit which accommodates the development agent and provides the development agent to the latent electrostatic image in a contact or non-contact manner is suitably usable and a development unit that accommodates the container to accommodate the development agent is preferable.

The development device is either of a single color development type or a multi-color development type. The development device suitably includes, for example, a stirrer to triboelectrically charge the development agent and a rotatable magnet roller.

In the development device, the toner and a carrier are mixed and stirred to triboelectrically charge the toner due to friction therebetween. The toner is then held on the surface of the rotatable magnet roller to form a magnet brush like a filament. Since the magnet roller is provided in the vicinity of the image bearing member, part of the toner forming the magnet brush borne on the surface of the magnet roller is transferred to the surface of the image bearing member by electric attraction force.

As a result, the latent electrostatic image is developed with the toner to form a visualized toner image on the surface of the image bearing member.

Transfer Process and Transfer Device

The transfer process mentioned above is a process in which the visualized image mentioned above is transferred to a recording medium. It is preferred that the visualized image is primarily transferred to an intermediate transfer body and thereafter secondarily transferred to the recording medium. Further, it is more preferred use a two-color toner, preferably a full color toner in the processes in which the visualized image is primarily transferred to an intermediate transfer body to form a complex transfer image and the complex transfer image is thereafter secondarily transferred to the recording medium.

The transfer process can be performed by, for example, charging the latent electrostatic image bearing member (photoreceptor) with a transfer charging device and by the transfer device. The transfer device preferably has a primary transfer device to form a complex transfer image by transferring the visual image to an intermediate transfer body and a secondary transfer device to transfer the complex transfer image to a recording medium.

There is no specific limit to the selection of the intermediate transfer body. Any known transfer member such as an intermediate transfer belt can be suitably selected and used.

The transfer device (the primary transfer body, the secondary transfer body) preferably has a transfer unit which peeling-charges the visualized image formed on the image bearing member (photoreceptor) to the side of the recording medium. One or more transfer devices can be provided.

Specific examples of the transfer units include, but are not limited to, a corona transfer unit using corona discharging, a transfer belt, a transfer roller, a pressure transfer roller, and an adhesive transfer unit.

There is no specific limitation to the recording medium and any known recording medium (typically paper) can be suitably used.

Fixing Process and Fixing Device

The fixing process is a process in which the visual image transferred to the recording medium is fixed by a fixing device. Fixing can be performed every time each color toner image is transferred or at once for a multi-color overlapped (superimposed) image.

Any fixing device can be suitably selected. Any known heating and pressure device can be used to a particular application. Known pressure and heating devices are preferably used and formed of, for example, a combination of a heating roller and a pressure roller or a combination of a heating roller, a pressure roller and an endless belt.

For example, a suitable fixing device has a heating body that has a heat-generating element, a film in contact with the heating body, and a pressing member that presses the hearing body via the film to fix the un-fixed image on a recording medium while the recording medium passes between the film and the pressing member. The heating temperature by the heating and pressure device is preferably from 80° C. to 200° C.

Also, any known optical fixing device can be used together with or in place of the fixing device and the fixing process described above.

The discharging process is a process in which a discharging bias is applied to the image bearing member to discharge the image bearing member and is suitably performed by a discharging device.

There is no specific limit to the discharging device and any known discharging device. For example, a discharging lamp, can be suitably selected as long as it can apply a discharging bias to the image bearing member.

The cleaning process is to remove the toner remaining on the image bearing member and can be conducted by the cleaning device.

There is no specific limit to the cleaning device and any known cleaner can be selected as long as it can remove the toner remaining on the image bearing member. Preferred specific examples of such cleaners include, but are not limited to, a magnetic brush cleaner, an electroconductive roller cleaner, a blade cleaner, a brush cleaner, and a web cleaner.

The recycling process is to return the toner removed in the cleaning process mentioned above to the development device for re-use. This recycling process is suitably conducted by a recycling device. There is no specific limit to the recycling device and any known conveying device, etc., can be used.

The controlling process mentioned above is to control each process described above and controlling can be suitably conducted by a controlling device (controller).

There is no specific limit to the control device as long as it can control the behavior of each device. Any control device is suitably usable. For example, devices such as a sequencer and a computer can be used.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis of Crystalline Polyester R0

202 parts of sebacic acid, 15 parts of adipic acid, 177 parts of 1,6-hexane diol, and 0.5 parts of tetrabutoxy titanate serving as a condensing catalyst were placed in a reaction container equipped with a condenser, a stirrer, and a nitrogen introducing tube to conduct reaction at 180° C. for eight hours in a nitrogen atmosphere while distilling away produced water. Next, reaction was continued for four hours while gradually heating the system to 220° C. and distilling away produced water and 1,6-hexane diol in a nitrogen atmosphere and continue the reaction with a reduced pressure of from 5 mmHg to 20 mmHg until the weight average molecular weight reached about 12,000 to obtain [Crystalline polyester R0]. The [Crystalline polyester R0] had a weight average molecular weight of 12,000 and a melting point of 60° C.

### Synthesis of Urethane-Modified Crystalline Polyester R1

202 parts of sebacic acid, 189 parts of 1,6-hexane diol, and 0.5 parts of dibutyltin oxide serving as a condensing catalyst were placed in a reaction container equipped with a condenser, a stirrer, and a nitrogen introducing tube to conduct reaction at 180° C. for eight hours in a nitrogen atmosphere while distilling away produced water. Next, reaction was continued for four hours while gradually heating the system to 220° C. and distilling away produced water and 1,6-hexane diol in a nitrogen atmosphere and continue the reaction with a reduced pressure of from 5 mmHg to 20 mmHg until the weight average molecular weight reached about 6,000 to obtain a crystalline polyester. The crystalline polyester had a weight average molecular weight of 6,000.

The thus-obtained crystalline polyester was transferred to a reaction container equipped with a condenser, a stirrer, and a nitrogen introducing tube and 300 parts of ethyl acetate and 38 parts of 4,4′-diphenyl methane diisocyanate (MDI) were added thereto to conduct reaction at 80° C. in a nitrogen atmosphere for five hours. Next, ethyl acetate was distilled away under a reduced pressure to obtain [Urethane-Modified crystalline polyester R1]. The [Crystalline urethane-modified polyester R1] had a weight average molecular weight of 10,000 and a melting point of 64° C.

### Synthesis of Non-Crystalline Polyester R2

222 parts of an adduct of bisphenol A with 2 mols of ethylene oxide, 129 parts of an adduct of bisphenol A with 2 mols of propylene oxide, 166 parts of isophthalic acid, and 0.5 part of tetrabutoxy titanate were placed in a reaction container equipped with a condenser, a stirrer, and a nitrogen introducing tube to conduct reaction at 230° C. for eight hours in a nitrogen atmosphere while distilling away produced water. Next, reaction was continued under a reduced pressure of from 5 mmHg to 20 mmHG. The system was cooled down to 180° C. (normal pressure) when the acid value reached 2 mmgKOH/g. Thereafter, 35 parts to trimellitic anhydride was added to conduct reaction for three hours to obtain [Non-Crystalline Polyester R2]. The [Crystalline polyester R2] had a weight average molecular weight of 8,000 and a glass transition point temperature of 62° C.

### Synthesis of Wax Dispersant 1

480 parts of xylene and 100 parts of paraffin wax (HNP-9, manufactured by NIPPON SEIRO CO., LTD.) were placed in a reaction container equipped with a stirrer and a thermometer. The system was heated followed by nitrogen replacement and thereafter heated to 170° C. Next, a liquid mixture of 740 parts of styrene, 100 parts of acrylonitril, 60 parts of butyl acrylate, 36 parts of di-t-butylperoxy hexahydro terephthalate, and 100 parts of xylene was dripped to the reaction container in three hours. Thereafter, the system was maintained at 170° C. for 30 minutes. Furthermore, subsequent to removal of solvent, [Wax dispersant 1] was obtained.

### Synthesis of Wax Dispersant 2

[Wax dispersant 2] was prepared in the same manner as described to obtain the [Wax dispersant 1] except that microcrystalline wax (BSQ-180, available from Baker-Petrolite Corporation) was used instead of paraffin wax (HNP-9, manufactured by NIPPON SEIRO CO., LTD.).

### Synthesis of Wax Dispersant 3

[Wax dispersant 3] was prepared in the same manner as described to obtain the [Wax dispersant 1] except that synthesized ester wax (WEP-5, manufactured by NOF CORPORATION) was used instead of paraffin wax (HNP-9, manufactured by NIPPON SEIRO CO., LTD.).

### Synthesis of Wax Dispersant 4

[Wax dispersant 4] was prepared in the same manner as described to obtain the [Wax dispersant 1] except that acidity group-modified polyolefin wax (UNICID® 350, available from Baker-Petrolite Corporation) was used instead of paraffin wax (HNP-9, manufactured by NIPPON SEIRO CO., LTD.).

### Synthesis of Wax Dispersant 5

[Wax dispersant 5] was prepared in the same manner as described to obtain the [Wax dispersant 1] except that hydroxyl group-modified paraffin wax (parachor 5001, available from Baker-Petrolite Corporation) was used instead of paraffin wax (HNP-9, manufactured by NIPPON SEIRO CO., LTD.).

### Preparation of Wax Liquid Dispersion W1

150 parts of paraffin wax (HNP-9, manufactured by NIPPON SEIRO CO., LTD.), 15 parts of [Wax dispersant 1], and 335 parts of ethylacetate were placed in a container equipped with a stirrer and a thermometer. Thereafter, the system was heated to 80° C. while being stirred and maintained at 80° C. for five hours. Next, subsequent to cooling down to 30° C. in one hour, the system was dispersed by a beads mill (ULTRAVISCOMILL, manufactured by Aimex Co., Ltd.) under the condition of liquid transfer speed of 1 kg/hour, disc circumference speed of 6 m/sec, 80 volume % filling of 0.5 mm zirconia beads, and 3 pass to obtain [Wax liquid dispersion W1].

### Preparation of Wax Liquid Dispersion W2

[Wax liquid dispersion W2] was obtained in the same manner as described to obtain the [Wax liquid dispersion W1] except that microcrystalline wax (BSQ-180, available from Baker-Petrolite Corporation) and the [Wax dispersant 2] were used instead of paraffin wax (HNP-9, manufactured by NIPPON SEIRO CO., LTD.) and [Wax dispersant 2], respectively.

### Preparation of Wax Liquid Dispersion W3

[Wax liquid dispersion W3] was obtained in the same manner as described to obtain the [Wax liquid dispersion W1] except that synthesized ester wax (WEP-5, manufactured by NOF CORPORATION) and the [Wax dispersant 3] were used instead of paraffin wax (HNP-9, manufactured by NIPPON SEIRO CO., LTD.) and [Wax dispersant 3], respectively.

### Preparation of Wax Liquid Dispersion W4

[Wax liquid dispersion W4] was obtained in the same manner as described to obtain the [Wax liquid dispersion W1] except that acidity group-modified polyolefin wax (UNICID® 350, available from Baker-Petrolite Corporation) and the [Wax dispersant 3] were used instead of paraffin wax (HNP-9, manufactured by NIPPON SEIRO CO., LTD.) and [Wax dispersant 4], respectively.

### Preparation of Wax Liquid Dispersion W5

[Wax liquid dispersion W5] was obtained in the same manner as described to obtain the [Wax liquid dispersion W1] except that hydroxyl group-modified paraffin wax (parachor 5001, available from Baker-Petrolite Corporation) and the [Wax dispersant 5] were used instead of paraffin wax (HNP-9, manufactured by NIPPON SEIRO CO., LTD.) and [Wax dispersant 5], respectively.

[Wax liquid dispersion W1] to [Wax liquid dispersion W5] were observed by an optical microscope with a magnifying power of 1,000. No particle having a particle diameter of 1 μm was seen, that is, the dispersion state of the wax was excellent.

### Preparation of Wax Liquid Dispersion W6

[Wax liquid dispersion W6] was obtained in the same manner as described to prepare [Wax liquid dispersion W3] except that three passes of bead mill was changed to one pass.

[Wax liquid dispersion W6] was observed by an optical microscope with a magnifying power of 1,000. Quite a number of coarse particles having a particle diameter of from 2 μm to 5 μm were seen.

Furthermore, for comparison, wax liquid dispersions were prepared in the same manner as described to prepare [Wax liquid dispersion W2] to [Wax liquid dispersion W5] except that [Wax liquid dispersion W1] was used instead of [Wax dispersant 2] to [Wax dispersant 5], respectively.

[Wax liquid dispersion W6] was observed by an optical microscope with a magnifying power of 1,000. Quite a number of coarse particles having a particle diameter of from 5 μm to 10 μm were seen.

### Preparation of Pigment Master Batch MB0

100 parts of [Crystalline polyester R0], 100 parts of carbon black (Printex 35, DBP oil absorption amount; 42 ml/100 g; pH: 9.5, manufactured by Evonik Degussa GmbH), and 50 parts of deionized water were mixed by using a HENSHEL MIXER (manufactured by NIPPON COKE & ENGINEERING CO., LTD.) followed by kneaded by a two-shaft roll. The kneading was started from 90° C. and the mixture was and cooled down gradually to 50° C. The thus-obtained mixture was pulverized by a pulverizer (manufactured by HOSOKWA MICRON CORPORATION) to manufacture [Pigment master batch MB0].

### Preparation of Pigment Master Batch MB 1

[Pigment master batch MB1] was prepared in the same manner as described to prepare [Pigment master batch MB0] except that [Urea-modified crystalline polyester R1] was used instead of [Crystalline polyester R0].

### Preparation of Oil Phases J1 to J16 and H1 to H9

One of the crystalline resins described above was placed in a container equipped with a thermometer and a stirrer. Subsequent to addition of ethyl acetate, the system was heated to the melting point of the crystalline resin or higher. Next, after adding one of the wax liquid dispersions described above and one of the pigment master batches, mixing was conducted at 50° C. and 5,000 rotation per minute (rpm) by a TK type HOMO MIXER (manufactured by PRIMIX Corporation) to obtain [Oil phase J1] to [Oil phase J16] and [Oil phase H1] to [Oil phase H9] having a solid portion concentration of 50% by weight (refer to Table 1).

TABLE 1

| | | | Addition | | |
|---|---|---|---|---|---|
| | | | amount of | Wax liquid | |
| | Crystalline resin | | non- | dispersion | |
| | | Addition | crystalline | | Addition |
| | | amount | polyester | | amount |
| Oil Phase | Kind | (parts) | (parts) | Kind | (part) |
| J1 | R0 | 32 | 68 | W1 | 52 |
| J2 | R0 | 37 | 63 | W1 | 107 |
| J3 | R0 | 45 | 55 | W1 | 198 |
| J4 | R0 | 68 | 32 | W1 | 108 |
| J5 | R0 | 100 | 0 | W1 | 108 |
| J6 | R0 | 83 | 17 | W1 | 196 |
| J7 | R0 | 100 | 0 | W4 | 108 |
| J8 | R0 | 100 | 0 | W5 | 108 |
| J9 | R1 | 32 | 68 | W1 | 52 |
| J10 | R1 | 37 | 63 | W1 | 107 |
| J11 | R1 | 45 | 55 | W1 | 198 |
| J12 | R1 | 68 | 32 | W1 | 108 |
| J13 | R1 | 100 | 0 | W1 | 108 |
| J14 | R1 | 83 | 17 | W1 | 196 |
| J15 | R1 | 83 | 17 | W5 | 196 |
| H1 | R0 | 27 | 73 | W1 | 12 |
| H2 | R0 | 28 | 72 | W1 | 21 |
| H3 | R0 | 31 | 69 | WI | 40 |
| H4 | R0 | 2 | 68 | W1 | 36 |
| H5 | R0 | 7 | 68 | W1 | 38 |
| H6 | R0 | 29 | 68 | W1 | 50 |
| H7 | R0 | 100 | 0 | W2 | 108 |
| H8 | R0 | 100 | 0 | W3 | 108 |
| H9 | R0 | 100 | 0 | W6 | 108 |

| | |
|---|---|
| Pigment | |
| master batch | Addition |

| | | Addition | amount of |
|---|---|---|---|
| | | amount | ethyl acetate |
| Oil Phase | Kind | (parts) | (parts) |
| J1 | MB0 | 22 | 105 |
| J2 | MB0 | 26 | 90 |
| J3 | MB0 | 32 | 65 |
| J4 | MB0 | 26 | 85 |
| J5 | MB0 | 26 | 89 |
| J6 | MB0 | 31 | 64 |
| J7 | MB0 | 26 | 89 |
| J8 | MB0 | 26 | 89 |
| J9 | MB1 | 22 | 105 |
| J10 | MB1 | 26 | 90 |
| J11 | MB1 | 32 | 65 |
| J12 | MB1 | 26 | 85 |
| J13 | MB1 | 26 | 89 |
| J14 | MB1 | 31 | 64 |
| J15 | MB1 | 31 | 64 |
| H1 | MB0 | 20 | 116 |
| H2 | MB0 | 20 | 113 |
| H3 | MB0 | 22 | 108 |
| H4 | MB0 | 10 | 74 |
| H5 | MB0 | 17 | 79 |
| H6 | MB0 | 21 | 100 |
| H7 | MB0 | 26 | 89 |
| H8 | MB0 | 26 | 89 |
| H9 | MB0 | 26 | 89 |

The [Oil phases] were used within five hours to avoid crystallization after being maintained in the container at 50° C.

### Preparation of Aqueous Phase

The following recipe was placed in a container equipped with a stirrer and a thermometer and stirred at 400 rpm for 15 minutes:

| | |
|---|---|
| Deionized water: | 683 parts |
| Sodium salt of sulfate of an adduct of | 16 parts |
| methacrylic acid with ethyleneoxide | |
| (EREMINORRS-30, manufactured by | |
| Sanyo Chemical Industries, Ltd.): | |
| Styrene: | 83 parts |
| Methacrylic acid: | 83 parts |
| n-butyl acrylate: | 110 parts |
| Ammonium persulfate: | 1 part |

Next, the system was heated to 75° C. and reacted for 5 hours. Furthermore, 30 parts of 1 weight % aqueous solution of ammonium persulfate was added and the system was aged at 75° C. for 5 hours to obtain a vinyl-based resin liquid dispersion. The volume average particle diameter of the vinyl-based resin liquid dispersion was 14 nm when measured by using a laser diffraction/scattering type particle size distribution analyzer (LA-920, manufactured by HORIBA, Ltd.). The vinyl-based resin had an acid value of 45 mg/KOH/g, a weight average molecular weight of 300,000, and a glass transition temperature of 60° C.

455 parts of deionized water, 7 parts of vinyl-based resin liquid dispersion, 17 parts of 48.5% by weight aqueous solution of sodium dodecyldiphenyl ether disulfonate (EREMINOR MON-7, manufactured by Sanyo Chemical Industries, Ltd.), and 41 parts of ethyl acetate were mixed and stirred to obtain an aqueous phase.

### Example 1

520 parts of deionized water was placed in a container equipped with a stirrer and a thermometer and thereafter heated to 40° C.

Next, 260 parts of [Oil phase J1] maintained at 50° C. was added. While being maintained at 40° C. to 50° C., the mixture was mixed for one minute by a TK type HOMO MIXER (manufactured by PRIMIX Corporation) to obtain an emulsified slurry.

The emulsified slurry was placed in a container equipped with a stirrer and a thermometer followed by removing the solvent at 60° C. for six hours to obtain a slurry.

The slurry was filtered with a reduced pressure to obtain a filtered cake. Then, 100 parts of deionized water was added to the filtered cake and the resultant was mixed by a TK type HOMOMIXER at 6,000 rpm for 5 minutes followed by filtration. 100 parts of 10% sodium hydroxide aqueous solution was added to the obtained filtered cake followed by mixing the resultant by a TK HOMOMIXER at 6,000 rpm for ten minutes. The mixture was filtered with a reduced pressure; Then, 100 parts of deionized water was added to the filtered cake and the resultant was mixed by a TK type HOMOMIXER at 6,000 rpm for 5 minutes followed by filtration; Thereafter, 300 parts of deionized water was added to the filtered cake and the resultant was mixed by a TK HOMOMIXER at 6,000 rpm for 5 minutes followed by filtration. This process was repeated three times.

The obtained filtered cake was dried by a circulation drier at 45° C. for 48 hours. The dried cake was sieved by using a screen having an opening of 75 μm to obtain mother particles.

100 parts of the mother particle and 1 part of hydrophobized silica (HDK-2000, manufactured by Wacker Chemie Corporation) were mixed by using a HENSCEL MIXER (manufactured by NIPPON COKE & ENGINEERING CO., LTD.) under a condition of a circumference speed of 30 m/s for 30 seconds followed by a one-minute break. This process was repeated five times. Next, the resultant was screened by a mesh having an opening of 35 μm to obtain toner.

### Examples 2 to 15

Toner of Example 2 to 15 was manufactured in the same manner as in Example 1 except that the oil phases J2 to J15 were used instead of the oil phase J1.

### Comparative Examples 1 to 9

Toner of Comparative Examples 1 to 9 was manufactured in the same manner as in Example 1 except that the oil phases H1 to H9 were used instead of the oil phase J1.

### Preparation of Liquid Dispersion of Crystalline Polyester

256 parts of 1,6-hexane diol, 225 parts of butane diol, 320 parts of fumaric acid, and 210 parts of sebacic acid were placed in a reaction container equipped with a stirrer, a nitrogen-introducing tube, a temperature sensor, and a rectifying column. The resultant was heated to 190° C. in one hour. 1.2 parts of dibutyl tin oxide was added thereto. Thereafter, while distilling away water produced, the system was heated to 240° C. in six hours and kept for three hours. Furthermore, 10 parts of trimellitic acid was added thereto and kept at 240° C. for one hour to obtain a non-crystalline polyester. The crystalline polyester had a melting point of 72° C. and an acid value of 25 mgKOH/g.

While maintaining the obtained crystalline polyester in melted and fused state, the crystalline polyester was transferred to a Manton-Gaulin high pressure HOMOGENIZER (manufactured by Gaulin Co., Ltd.) at 50 g/min. At the same time, 0.37% by weight of diluted ammonia water placed in an aqueous medium tank was transferred to the Manton-Gaulin high pressure HOMOGENIZER at 0.1 L/min. while heating to 120° C. by a heat exchanger.

The resultant was subject to emulsification treatment at a pressure at this point set to 150 kg/cm² to obtain a crystalline polyester liquid dispersion. The volume average particle diameter of the vinyl-based resin liquid dispersion was 30 nm when measured by using a laser diffraction/scattering type particle size distribution analyzer (LA-920, manufactured by HORIBA, Ltd.).

### Example 16

Toner of Example 12 was obtained in the same manner as in Example 12 except that the following treatment was conducted before the slurry was filtered with a reduced pressure.

48 parts of liquid dispersion of crystalline polyester was added to the slurry. Thereafter, 8 parts of 10% by weight of aqueous solution of calcium chloride serving as agglomerating agent was gradually dripped thereto followed by stirring at 75° C. for one hour.

### Example 17

Toner of Example 17 was manufactured in the same manner as in Example 16 except that the oil phases J13 was used instead of the oil phase J12.

### Example 18

Toner of Example 18 was manufactured in the same manner as in Example 16 except that the oil phases J14 was used instead of the oil phase J12.

### Example 19

Toner of Example 19 was manufactured in the same manner as in Example 16 except that the oil phases J15 was used instead of the oil phase J12.

The properties of the toner are shown in Table 2.

TABLE 2

| | | | | | | | Wax |
|---|---|---|---|---|---|---|---|
| | | | | | | | solu- |
| | | | | | Peak of tackiness | | bility |
| | Sc1 | Sw1 | Sw2/ | Sw1/ | Temp. | Tackiness | (% by |
| | (J/g) | (J/g) | Sw1 | Sc1 | (° C.) | (g/f) | weight) |
| Example 1 | 26 | 3.1 | 0.55 | 0.12 | 55 | 15 | 12 |
| Example 2 | 23 | 5.3 | 0.58 | 0.23 | 55 | 10 | 12 |
| Example 3 | 21 | 7.4 | 0.65 | 0.35 | 50 | 5 | 12 |
| Example 4 | 42 | 9.7 | 0.65 | 0.23 | 45 | 22 | 12 |
| Example 5 | 65 | 7.8 | 0.63 | 0.12 | 40 | 29 | 12 |
| Example 6 | 38 | 13.3 | 0.70 | 0.35 | 50 | 8 | 12 |
| Example 7 | 69 | 11.0 | 0.71 | 0.16 | 45 | 23 | 9 |
| Example 8 | 67 | 10.1 | 0.80 | 0.15 | 40 | 15 | 5 |
| Example 9 | 27 | 4.3 | 0.57 | 0.16 | 55 | 16 | 14 |
| Example 10 | 23 | 6.4 | 0.59 | 0.28 | 55 | 8 | 14 |
| Example 11 | 22 | 8.4 | 0.72 | 0.38 | 50 | 6 | 14 |
| Example 12 | 43 | 10.8 | 0.73 | 0.25 | 50 | 23 | 14 |
| Example 13 | 67 | 14.7 | 0.78 | 0.22 | 45 | 27 | 14 |
| Example 14 | 36 | 16.2 | 0.82 | 0.45 | 45 | 8 | 14 |
| Example 15 | 37 | 19.2 | 0.95 | 0.52 | 50 | 3 | 6 |
| Example 16 | 45 | 10.8 | 0.70 | 0.24 | 50 | 23 | 14 |
| Example 17 | 70 | 14.7 | 0.77 | 0.21 | 50 | 27 | 14 |
| Example 18 | 38 | 16.2 | 0.78 | 0.43 | 45 | 8 | 14 |
| Example 19 | 38 | 19.2 | 0.92 | 0.50 | 50 | 3 | 6 |
| Comparative | 32 | 1.0 | 0.51 | 0.03 | 50 | 29 | 12 |
| Example 1 | | | | | | | |
| Comparative | 29 | 2.0 | 0.52 | 0.07 | 50 | 25 | 12 |
| Example 2 | | | | | | | |
| Comparative | 30 | 2.7 | 0.51 | 0.09 | 55 | 20 | 12 |
| Example 3 | | | | | | | |
| Comparative | 8 | 3.6 | 0.54 | 0.45 | 60 | 8 | 12 |
| Example 4 | | | | | | | |
| Comparative | 12 | 3.0 | 0.51 | 0.25 | 55 | 11 | 12 |
| Example 5 | | | | | | | |
| Comparative | 19 | 3.6 | 0.53 | 0.19 | 50 | 14 | 12 |
| Example 6 | | | | | | | |
| Comparative | 67 | 8.7 | 0.48 | 0.13 | 45 | 32 | 15 |
| Example 7 | | | | | | | |
| Comparative | 68 | 8.2 | 0.42 | 0.12 | 40 | 35 | 21 |
| Example 8 | | | | | | | |
| Comparative | 66 | 9.2 | 0.25 | 0.14 | 45 | 45 | 21 |
| Example 9 | | | | | | | |

Sc1, Sw1, and Sw2

Using a differential scanning calorimetry (DSC) (TA-60WS and DSC-60, manufactured by Shimadzu Corporation), Sc1, Sc2, and Sw1 were measured under the conditions mentioned above.

Solubility of Wax

70 g of ethyl acetate and 30 g of crystalline resin were placed in a flask equipped with a condenser. Thereafter, the mixture was gradually heated while being stirred until the resin was completely dissolved. Then, the solution was cooled down to 50° C. While keeping the solution at 50° C., wax was gradually added and the amount of the wax above which it was not dissolved any more was determined. While keeping the solution at 50° C., the resultant was stirred for one hour and to be found that there was non-dissolved components. In a case in which the non-dissolved components were dissolved, wax was added more until the amount of the wax above which it was not dissolved any more was determined.

Tackiness (Tacking Force)

Using Imagio Neo C6000 Prowo (manufactured by Ricoh Co., Ltd.), a solid image on which 0.55 mg/cm² to 0.65 mg/cm² of the toner were attached was output under the machine standard fixing conditions.

Next, using a tacking tester (TACKINESS TESTER TA-II type, manufactured by Rhesca Corporation) and a probe having a diameter of 5 mm, the tackiness of the solid image was measured. To be specific, the image was heated to 110 Rhesca ° C. and kept at 110° C. for 10 minutes. Thereafter, the image was cooled down by 10° C. The tackiness was measured at 10° C. to 30° C. under the following measuring conditions. The time to be taken for cooling down and measuring was 3 minutes for each temperature.

Measuring mode: ConstantLoad
ImmersionSpeed (press-in speed): 30 mm/minute
TestSpeed (Pull-up speed): 5 mm/minute
PreLoad (press-in load): 200 gf
PressTime (Press-in Time): 3 seconds
Distance (Pull-up distance): 1 mm

### HeatUpWait: No

Manufacturing of Carrier

100 parts of silicone resin (ORGANO STRAIGHT SILICONE, RS213, manufactured by Dow Corning Toray Co., Ltd.), 5 parts of γ-(2-aminoethyl)aminopropyl trimethoxy silane, 10 parts of carbon black (MA-100, manufactured by Mitsubishi Chemical Corporation), and 100 parts of toluene were dispersed using a HOMOMIXER for 20 minutes to obtain a liquid application of cover layer.

Using a fluid bed type coating device, the liquid application of cover layer was applied to the surface of 1,000 parts of spherical ferrite having a volume average particle diameter of 35 μm to obtain toner carrier.

Thereafter, two-component development agents were prepared by using the toner of Examples 1 to 15, Comparative Examples 1 to 9 and the carrier.

Manufacturing Two Component Development Agent

Two component agents were manufactured by mixing 5 parts of the toner and 95 parts of the carrier.

Thereafter, using the two component development agent, the fixability (lowest fixing temperature, highest fixing temperature, fixing range), the marks of members such as discharging rollers and ribs on images, and the amount of agglomeration of the two component development agent were evaluated.

Lowest Fixing Temperature (Low Temperature Fixability)

A solid image having a dimension of 3 cm×8 cm with an attachment amount of toner from 0.75 mg/cm² to 0.95 mg/cm² was output on a photocopying printing sheet (<70>, manufactured by Ricoh Business Expert Co., Ltd.) by using Imagio Neo C600 Prowo (manufactured by Ricoh Co., Ltd.) to evaluate the lowest fixing temperature. The solid image was fixed by changing the temperature of the fixing belt. Drawing was conducted on the surface of the formed image under a load of 50 g by using a drawing tester (AD-401, manufactured by Ueshima Seisakusho Co., Ltd.) and a ruby needle having a point radius of 260 μm to 320 μm and a point angle of 60° and thereafter rubbed by a fiber (HONECOTTO #440, available from SAKATA INX ENG. CO., LTD.) five times. The solid image was formed at a position 3.0 cm from the leading end of the sheet relative to the sheet transfer direction. The speed of the sheet passing through the nipping portion of the fixing device was 280 mm/s.

Highest Fixing Temperature (Hot Offset Resistance)

A solid image having a dimension of 3 cm×8 cm with an attachment amount of toner from 0.75 mg/cm² to 0.95 mg/cm² was output on a photocopying printing sheet (6200, manufactured by Ricoh Co., Ltd.) by using Imagio Neo C600 Prowo (manufactured by Ricoh Co., Ltd.) to evaluate the highest fixing temperature. The solid image was fixed by changing the temperature of the fixing belt. Whether hot offset occurred or not was checked by visual confirmation. The highest temperature above which hot offset occurs was determined as the highest fixing temperature. In addition, the difference between the lowest fixing temperature and the highest fixing temperature were defined as the fixing range. The solid image was formed at a position 3.0 cm from the leading end of the sheet relative to the sheet transfer direction. The speed of the sheet passing through the nipping portion of the fixing device was 280 mm/s.

Marks on Image of Member that Contacts Image During Transfer Thereof.

A solid image having a dimension of 3 cm×8 cm with an attachment amount of toner from 0.75 mg/cm² to 0.95 mg/cm² was output on a photocopying printing sheet (6200, manufactured by Ricoh Co., Ltd.) by using Imagio Neo C600 Prowo (manufactured by Ricoh Co., Ltd.) to evaluate the marks on image of the members such as discharging rollers and ribs that contact the image during transfer thereof. The temperature of the fixing belt was set at the machine standard fixing temperature to fix the solid image on the sheet. The evaluation criteria are as follows:

B (Bad): the portion which was transferred by the discharging rollers were visually confirmed ribbon-like form and streaks of the ribs were visually confirmed on the white background.
F (Fair): the portion which was transferred by the discharging rollers were visually confirmed ribbon-like form when the solid image was slanted to about 45° and streaks of the ribs were visually confirmed partially on the white background.
G (Good): Streaks of the ribs were not visually confirmed on the white background but were apparent by gloss difference.
E (Excellent): The portion transferred by the discharging roller and the streaks of ribs were not discerned.

Amount of Agglomeration

In the Imagio Neo C600 Prowo (manufactured by Ricoh Co., Ltd.), the toner was stirred in the non-image forming mode in which no toner was consumed and thereafter the two component development agent was taken out. Next, the two component development agent was screened by using a sieve having an opening of 50 μm to measure the amount of the toner remaining on the screen. Furthermore, the obtained result was converted to the amount (mg) per 100 g of the two component development agent.

The evaluation results about the fixability, the marks of the members such as discharging rollers and ribs, and the agglomeration amount are shown in Table 3.

TABLE 3

| | | | | Marks of | |
|---|---|---|---|---|---|
| | Lowest | | | members | |
| | fixing | Highest | | such as | |
| | temper- | fixing | Fixing | discharging | Amount of |
| | ature | temperature | range | rollers, ribs, | agglom- |
| | (° C.) | (° C.) | (° C.) | etc. | eration |
| Example 1 | 120 | 170 | 50 | G | — |
| Example 2 | 120 | 190 | 70 | G | — |
| Example 3 | 120 | >200 | >80 | E | — |
| Example 4 | 110 | 160 | 50 | G | — |
| Example 5 | 105 | 165 | 60 | F | — |
| Example 6 | 110 | 180 | 70 | E | — |
| Example 7 | 105 | 165 | 60 | G | — |
| Example 8 | 105 | 160 | 55 | E | — |
| Example 9 | 110 | 175 | 65 | G | — |
| Example 10 | 115 | 190 | 75 | E | — |
| Example 11 | 115 | >200 | >85 | E | — |
| Example 12 | 105 | 170 | 65 | G | 10 |
| Example 13 | 100 | 170 | 70 | G | 15 |
| Example 14 | 100 | 190 | 90 | E | 22 |
| Example 15 | 95 | 195 | 100 | E | 13 |
| Example 16 | 105 | 170 | 65 | G | 5 |
| Example 17 | 100 | 170 | 70 | G | 7 |
| Example 18 | 100 | 190 | 90 | E | 3 |
| Example 19 | 95 | 195 | 100 | E | 0 |
| Comparative | 130 | 140 | 10 | B | — |
| Example 1 | | | | | |
| Comparative | 125 | 150 | 25 | F | — |
| Example 2 | | | | | |
| Comparative | 125 | 160 | 35 | G | — |
| Example 3 | | | | | |
| Comparative | 150 | 200 | 50 | G | — |
| Example 4 | | | | | |
| Comparative | 140 | 190 | 50 | G | — |
| Example 5 | | | | | |
| Comparative | 135 | 180 | 45 | G | — |
| Example 6 | | | | | |
| Comparative | 110 | 160 | 50 | B | — |
| Example 7 | | | | | |
| Comparative | 115 | 160 | 45 | B | — |
| Example 8 | | | | | |
| Comparative | 120 | 150 | 30 | B | — |
| Example 9 | | | | | |

As seen in Table 3, the toner of Examples 1 to 19 were good about the low temperature fixability and the hot offset resistance, thereby suppressing the occurrence of the marks of discharging rollers, ribs, etc.

To the contrary, since the ratio of Sw1 to Sc1 of the toner of Comparative Examples 1 to 3 was from 0.03 to 0.09, the hot offset resistance thereof was worsened.

Since Sc1 of the toner of Comparative Examples 4 to 6 ranged from 8 J/g to 19 J/g, the low temperature fixability was worsened.

Since the ratio of Sw2 to Sw1 of the toner of Comparative Examples 7 to 9 ranged from 0.25 to 0.48, the marks of discharging rollers, ribs, etc. occurred.

Having now fully described embodiments of the present invention, it will be apparent to one of ordinary skill in the art that many changes and modifications can be made thereto without departing from the spirit and scope of embodiments of the invention as set forth herein.

What is claimed is:

1. Toner comprising:
a mother toner particle comprising:
a crystalline resin; and
wax; and
a coloring agent,
wherein an area of endothermic peak derived from the crystalline resin during a first temperature rising as measured by differential scanning calorimetry is at least 20 J/g,
wherein a ratio of an area of endothermic peak derived from the wax during a second time temperature rising as measured by differential scanning calorimetry (DSC) to an area of endothermic peak derived from the wax during a first time temperature rising as measured by differential scanning calorimetry is at least 0.50,
wherein a ratio of the area of endothermic peak derived from the wax during a first time temperature rising as measured by differential scanning calorimetry to the area of endothermic peak derived from the crystalline resin during a first temperature rising as measured by differential scanning calorimetry is at least 0.10.

2. The toner according to claim 1,
wherein the area of endothermic peak derived from the wax during a first temperature rising as measured by differential scanning calorimetry is 2 J/g,
wherein a peak of tackiness of a fixed toner image during cooling down is 30 gf at most and present between 30° C. and 100° C. when an attachment amount of the toner is 0.55 mg/cm² to 0.65 mg/cm².

3. The toner according to claim 1, wherein the crystalline resin comprises a crystalline resin having at least one of a urethane bond or a urethane bond in a main chain thereof.

4. The toner according to claim 1, wherein the wax has a solubility of 10% by weight or less in a 30% by weight ethylacetate solution of the crystalline resin at 50° C.

5. The toner according to claim 1, wherein the wax has a carboxylic acid group or a hydroxy group.

6. The toner according to claim 1, wherein the mother toner particle has a layer comprising a crystalline resin, which forms a surface of the mother toner particle

7. The toner according to claim 6, wherein the layer comprises crystalline resin particles.

8. A development agent comprising:
toner carrier; and
the toner of claim 1.

9. An image forming method comprising:
charging a surface of an image bearing member;
irradiating the surface of the image bearing member to form a latent electrostatic image thereon;
developing the latent electrostatic image with the toner of claim 1 to obtain a visible image;
transferring the visible image to a recording medium;
removing residual toner remaining on the surface of the image bearing member; and
fixing the visible image transferred onto the recording image on the recording medium.
